(19) United States
(12) Patent Application Publication
(10) Pub. No.: US 2023/0345298 A1
(43) Pub. Date: Oct. 26, 2023

(54) DEADLINE-BASED DATA PACKETS

(71) Applicant: QUALCOMM Incorporated, San Diego, CA (US)

(72) Inventors: Hyun Yong LEE, San Diego, CA (US); Ravi AGARWAL, San Diego, CA (US); Prashanth Haridas HANDE, San Diego, CA (US); Peerapol TINNAKORNSRISUPHAP, San Diego, CA (US); Yann LEBRUN, Velizy-Villacoublay (FR); Diana MAAMARI, San Diego, CA (US); Mickael MONDET, Louannec (FR); Dario Serafino TONESI, San Diego, CA (US); Miguel GRIOT, La Jolla, CA (US)

(21) Appl. No.: 18/300,311

(22) Filed: Apr. 13, 2023

Related U.S. Application Data
(60) Provisional application No. 63/363,564, filed on Apr. 25, 2022.
(60) Provisional application No. 63/364,676, filed on May 13, 2022.

(51) Int. Cl. H04W 28/02; H04L 47/283; H04L 47/56

(52) U.S. Cl. CPC H04W 28/0268; H04L 47/283; H04L 47/564

(57) ABSTRACT

Various aspects of the present disclosure generally relate to wireless communication. In some aspects, a network node may receive an indication of a deadline for transmission of a protocol data unit (PDU) set, the indication of the deadline including one or more of: an indication of a jitter of the PDU set, an indication of a packet delay budget that is based at least in part on the jitter of the PDU set and a nominal PDU set delay budget (PSDB), or an indication of an absolute time of the deadline. The network node may transmit the PDU set at a time that is based at least in part on the indication of the deadline. Numerous other aspects are described.

### CROSS-REFERENCE TO RELATED APPLICATIONS

This Patent Application claims priority to U.S. Provisional Patent Application No. 63/363,564, filed on Apr. 25, 2022, entitled “DEADLINE-BASED DATA PACKETS,” and to U.S. Provisional Patent Application No. 63/364,676, filed on May 13, 2022, entitled “DEADLINE-BASED DATA PACKETS,” and assigned to the assignee hereof. The disclosures of the prior Applications are considered part of and are incorporated by reference into this Patent Application.

### FIELD OF THE DISCLOSURE

Aspects of the present disclosure generally relate to wireless communication and to techniques and apparatuses for deadline-based data packets.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node. The method may include receiving an indication of a deadline for transmission of a protocol data unit (PDU) set, the indication of the deadline including one or more of an indication of a jitter of the PDU set, an indication of a packet delay budget that is based at least in part on the jitter of the PDU set and a nominal PDU set delay budget (PSDB), or an indication of an absolute time of the deadline. The method may include transmitting the PDU set at a time that is based at least in part on the indication of the deadline.

Some aspects described herein relate to a method of wireless communication performed by an application server. The method may include providing an indication of a deadline for transmission of a PDU set, the indication of the deadline including one or more of an indication of a jitter of the PDU set, an indication of a packet delay budget that is based at least in part on the jitter of the PDU set and a nominal PSDB, or an indication of an absolute time of the deadline. The method may include receiving the PDU set at a time that is based at least in part on the indication of the deadline.

Some aspects described herein relate to a network node for wireless communication. The network node may include a memory and one or more processors coupled to the memory. The one or more processors may be configured to receive an indication of a deadline for transmission of a PDU set, the indication of the deadline including one or more of. The one or more processors may be configured to transmit the PDU set at a time that is based at least in part on the indication of the deadline.

Some aspects described herein relate to an application server for wireless communication. The application server may include a memory and one or more processors coupled to the memory. The one or more processors may be configured to provide an indication of a deadline for transmission of a PDU set, the indication of the deadline including one or more of. The one or more processors may be configured to receive the PDU set at a time that is based at least in part on the indication of the deadline.

Some aspects described herein relate to a non-transitory computer-readable medium that stores a set of instructions for wireless communication by a network node. The set of instructions, when executed by one or more processors of the network node, may cause the network node to receive an indication of a deadline for transmission of a PDU set, the indication of the deadline including one or more of. The set of instructions, when executed by one or more processors of the network node, may cause the network node to transmit the PDU set at a time that is based at least in part on the indication of the deadline.

Some aspects described herein relate to a non-transitory computer-readable medium that stores a set of instructions for wireless communication by a one or more instructions that, when executed by one or more processors of an application server. The set of instructions, when executed by one or more processors of the one or more instructions that, when executed by one or more processors of an application server, may cause the one or more instructions that, when executed by one or more processors of an application server to provide an indication of a deadline for transmission of a PDU set, the indication of the deadline including one or more of. The set of instructions, when executed by one or more processors of the one or more instructions that, when executed by one or more processors of an application server, may cause the one or more instructions that, when executed by one or more processors of an application server to receive the PDU set at a time that is based at least in part on the indication of the deadline.

Some aspects described herein relate to an apparatus for wireless communication. The apparatus may include means for receiving an indication of a deadline for transmission of a PDU set, the indication of the deadline including one or more of an indication of a jitter of the PDU set, an indication of a packet delay budget that is based at least in part on the jitter of the PDU set and a nominal PSDB, or an indication of an absolute time of the deadline. The apparatus may include means for transmitting the PDU set at a time that is based at least in part on the indication of the deadline.

Some aspects described herein relate to an apparatus for wireless communication. The apparatus may include means for providing an indication of a deadline for transmission of a PDU set, the indication of the deadline including one or more of an indication of a jitter of the PDU set, an indication of a packet delay budget that is based at least in part on the jitter of the PDU set and a nominal PSDB, or an indication of an absolute time of the deadline. The apparatus may include means for receiving the PDU set at a time that is based at least in part on the indication of the deadline.

Some aspects described herein relate to a method of wireless communication performed by a user equipment (UE). The method may include transmitting, to a network node, an indication of one or more of a deadline, a periodicity, a nominal packet delay budget, a jitter of burst arrival times, or a nominal arrival time of data packets of a communication session. The method may include receiving one or more data packets based at least in part on the one or more data packets arriving at or before the deadline.

Some aspects described herein relate to a method of wireless communication performed by a network node. The method may include receiving an indication of one or more of a deadline, a periodicity, a nominal packet delay budget, a jitter of burst arrival times, or a nominal arrival time associated with data packets of a communication session. The method may include transmitting one or more data packets based at least in part on the one or more data packets transmitted at or before the deadline.

Some aspects described herein relate to a UE for wireless communication. The UE may include a memory and one or more processors coupled to the memory. The one or more processors may be configured to transmit, to a network node, an indication of one or more of a deadline, a periodicity, a nominal packet delay budget, a jitter of burst arrival times, or a nominal arrival time of data packets of a communication session. The one or more processors may be configured to receive one or more data packets based at least in part on the one or more data packets arriving at or before the deadline.

Some aspects described herein relate to a network node for wireless communication. The network node may include a memory and one or more processors coupled to the memory. The one or more processors may be configured to receive an indication of one or more of a deadline, a periodicity, a nominal packet delay budget, a jitter of burst arrival times, or a nominal arrival time associated with data packets of a communication session. The one or more processors may be configured to transmit one or more data packets based at least in part on the one or more data packets transmitted at or before the deadline.

Some aspects described herein relate to a non-transitory computer-readable medium that stores a set of instructions for wireless communication by a UE. The set of instructions, when executed by one or more processors of the UE, may cause the UE to transmit, to a network node, an indication of one or more of a deadline, a periodicity, a nominal packet delay budget, a jitter of burst arrival times, or a nominal arrival time of data packets of a communication session. The set of instructions, when executed by one or more processors of the UE, may cause the UE to receive one or more data packets based at least in part on the one or more data packets arriving at or before the deadline.

Some aspects described herein relate to a non-transitory computer-readable medium that stores a set of instructions for wireless communication by a network node. The set of instructions, when executed by one or more processors of the network node, may cause the network node to receive an indication of one or more of a deadline, a periodicity, a nominal packet delay budget, a jitter of burst arrival times, or a nominal arrival time associated with data packets of a communication session. The set of instructions, when executed by one or more processors of the network node, may cause the network node to transmit one or more data packets based at least in part on the one or more data packets transmitted at or before the deadline.

Some aspects described herein relate to an apparatus for wireless communication. The apparatus may include means for transmitting, to a network node, an indication of one or more of a deadline, a periodicity, a nominal packet delay budget, a jitter of burst arrival times, or a nominal arrival time of data packets of a communication session. The apparatus may include means for receiving one or more data packets based at least in part on the one or more data packets arriving at or before the deadline.

Some aspects described herein relate to an apparatus for wireless communication. The apparatus may include means for receiving an indication of one or more of a deadline, a periodicity, a nominal packet delay budget, a jitter of burst arrival times, or a nominal arrival time associated with data packets of a communication session. The apparatus may include means for transmitting one or more data packets based at least in part on the one or more data packets transmitted at or before the deadline.

Aspects generally include a method, apparatus, system, computer program product, non-transitory computer-readable medium, user equipment, base station, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a jitter distribution, in accordance with the present disclosure.

FIG. 5 is a diagram illustrating an example of packet delay budget constraints on jitter-based communications, in accordance with the present disclosure.

FIGS. 6-10 are diagrams illustrating examples associated with deadline-based data packets, in accordance with the present disclosure.

FIGS. 11-14 are diagrams illustrating example processes associated with deadline-based data packets, in accordance with the present disclosure.

FIGS. 15-17 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

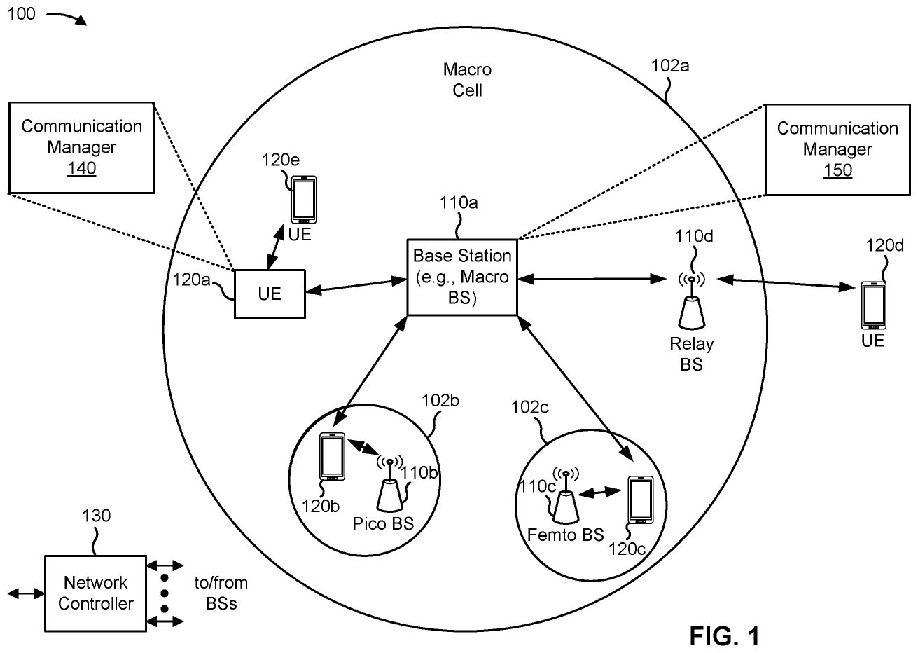

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network node, an indication of one or more of a deadline, a periodicity, a nominal packet delay budget, a jitter of burst arrival times, or a nominal arrival time of data packets of a communication session; and receive one or more data packets based at least in part on the one or more data packets arriving at or before the deadline. Additionally, or alternatively, the communication manager 140 may perform one or more other operations described herein.

In some aspects, the network node may include a communication manager 150. As described in more detail elsewhere herein, the communication manager 150 may receive an indication of one or more of a deadline, a periodicity, a nominal packet delay budget, a jitter of burst arrival times, or a nominal arrival time associated with data packets of a communication session; and transmit one or more data packets based at least in part on the one or more data packets transmitted at or before the deadline.

As described in more detail elsewhere herein, the communication manager 150 may receive an indication of a deadline for transmission of a protocol data unit (PDU) set, the indication of the deadline including one or more of: an indication of a jitter of the PDU set, an indication of a packet delay budget that is based at least in part on the jitter of the PDU set and a nominal PSDB, or an indication of an absolute time of the deadline; and transmit the PDU set at a time that is based at least in part on the indication of the deadline. Additionally, or alternatively, the communication manager 150 may perform one or more other operations described herein.

In some aspects, an application server may communicate with a UE via the wireless network 100. In some aspects, the application server may communicate with the network node and/or an additional network node that is in communication with the network node. The application server may provide an indication of a deadline for transmission of a PDU set, the indication of the deadline including one or more of: an indication of a jitter of the PDU set, an indication of a packet delay budget that is based at least in part on the jitter of the PDU set and a nominal PSDB, or an indication of an absolute time of the deadline; and receive the PDU set at a time that is based at least in part on the indication of the deadline. Additionally, or alternatively, the application server may perform one or more other operations described herein.

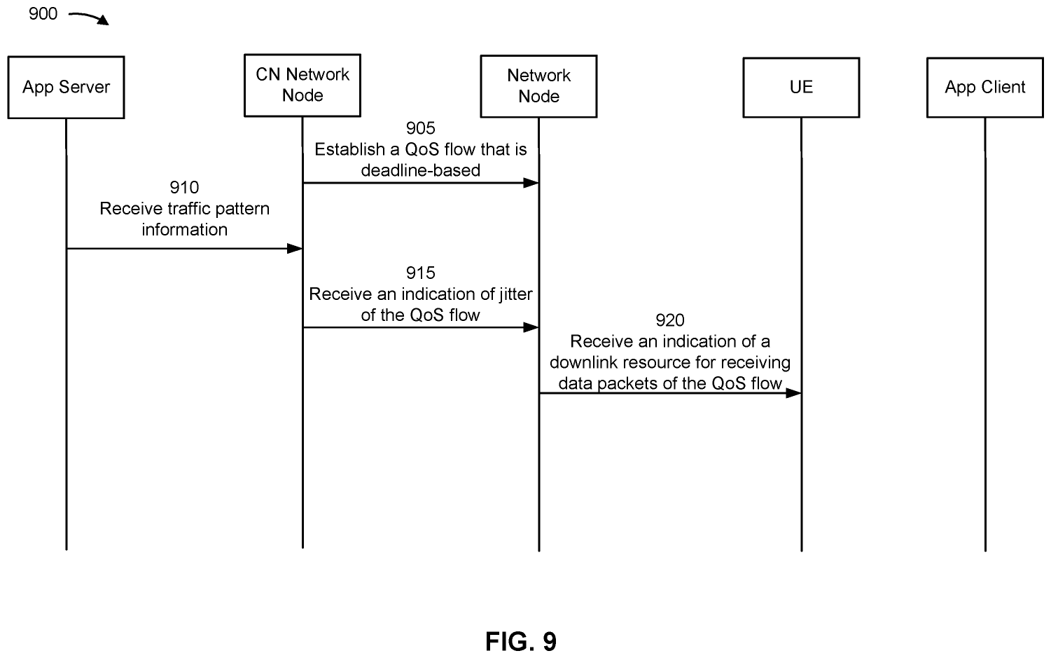

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

As indicated above, FIG. 1 is provided as an example. Other examples may differ from what is described with regard to FIG. 1.

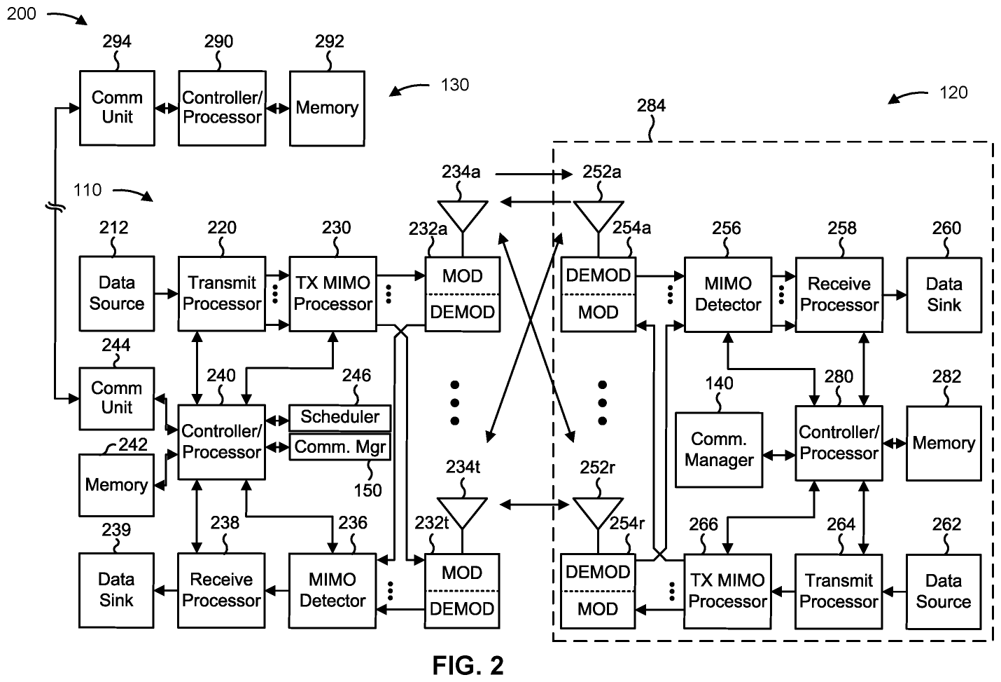

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

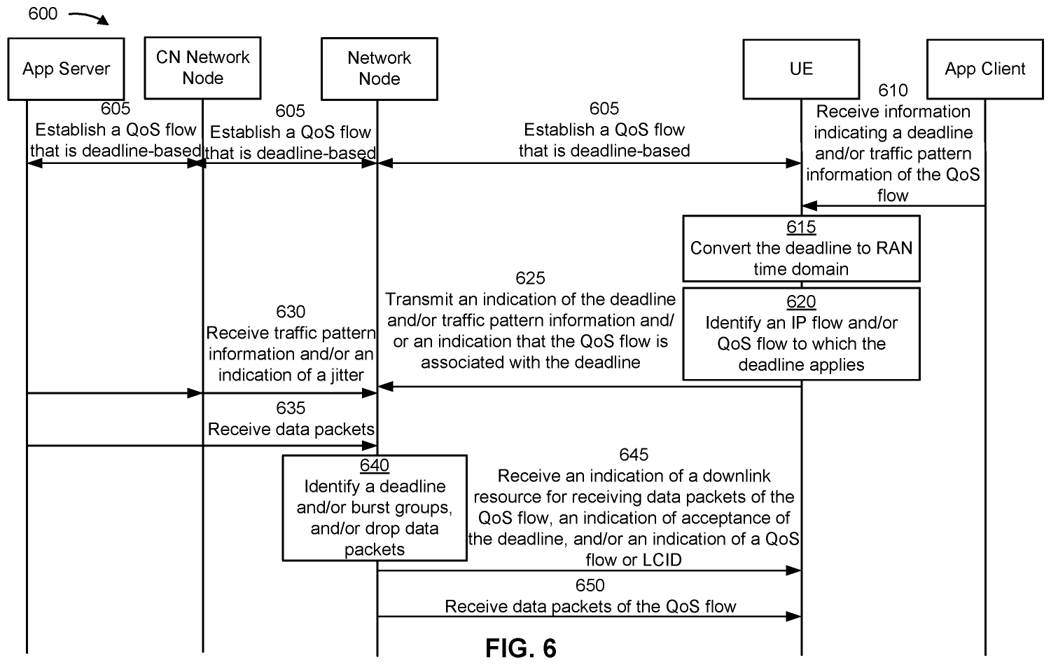

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

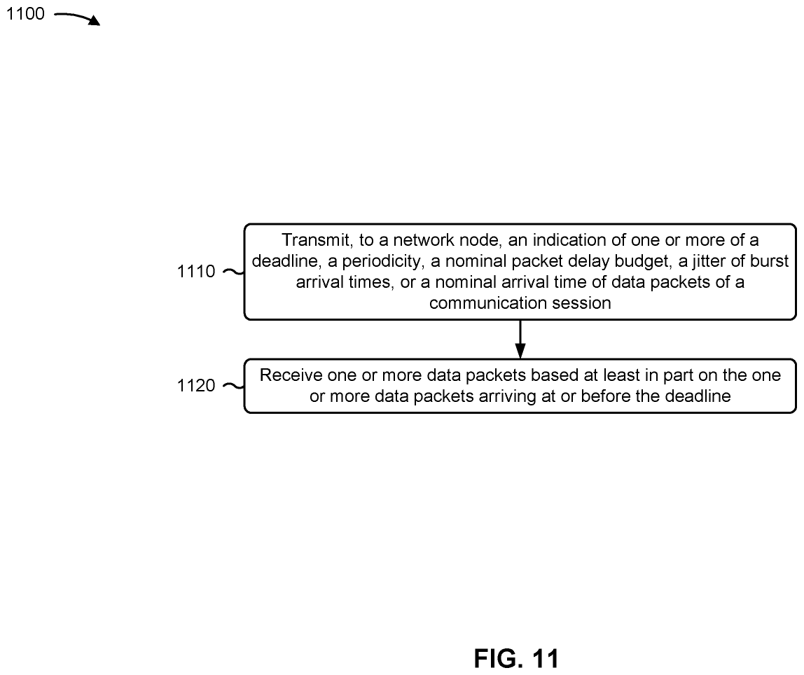

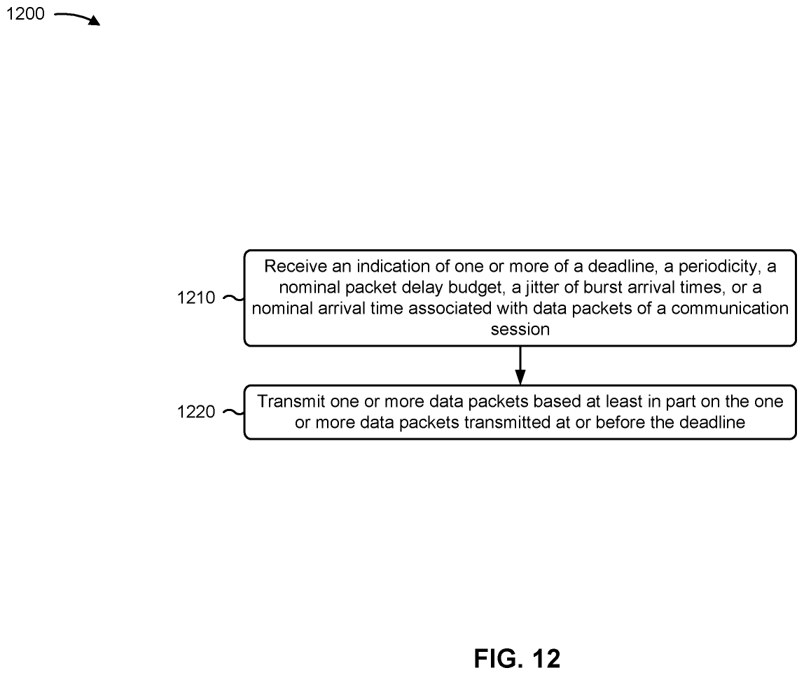

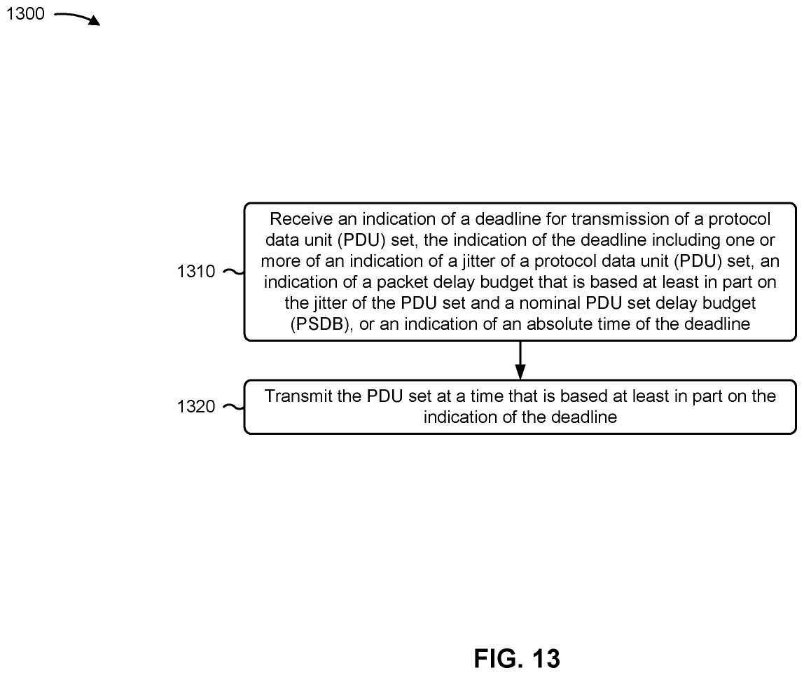

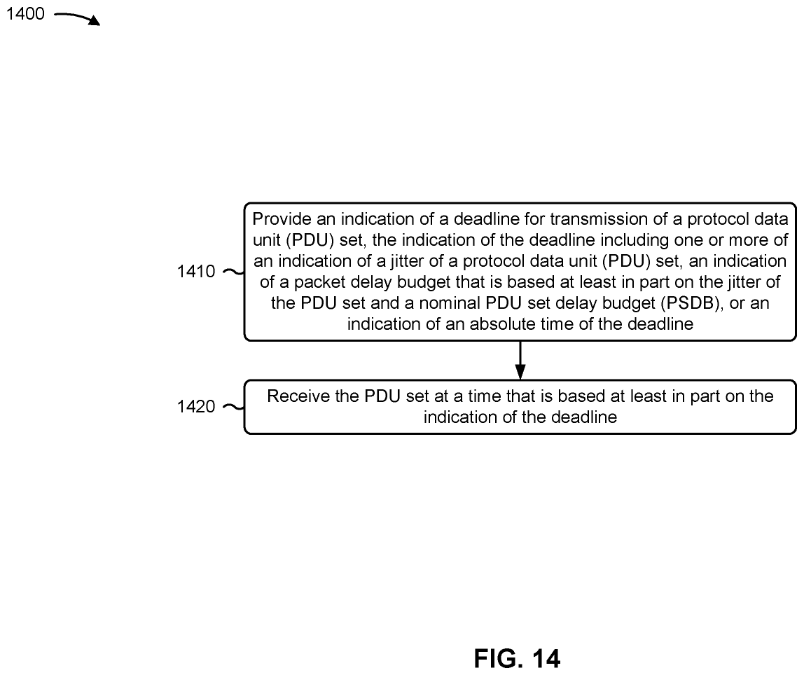

The controller/processor 240 of the base station 110, the controller/processor 280 of the UE 120, and/or any other component(s) of FIG. 2 may perform one or more techniques associated with deadline-based data packets, as described in more detail elsewhere herein. In some aspects, the network node described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 11 of FIG. 11, process 1200 of FIG. 12, process 1300 of FIG. 13, process 1400 of FIG. 14, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 11 of FIG. 11, process 1200 of FIG. 12, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE includes means for transmitting, to a network node, an indication of one or more of a deadline, a periodicity, a nominal packet delay budget, a jitter of burst arrival times, or a nominal arrival time of data packets of a communication session; and/or means for receiving one or more data packets based at least in part on the one or more data packets arriving at or before the deadline. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for receiving an indication of one or more of a deadline, a periodicity, a nominal packet delay budget, a jitter of burst arrival times, or a nominal arrival time associated with data packets of a communication session; and/or means for transmitting one or more data packets based at least in part on the one or more data packets transmitted at or before the deadline. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

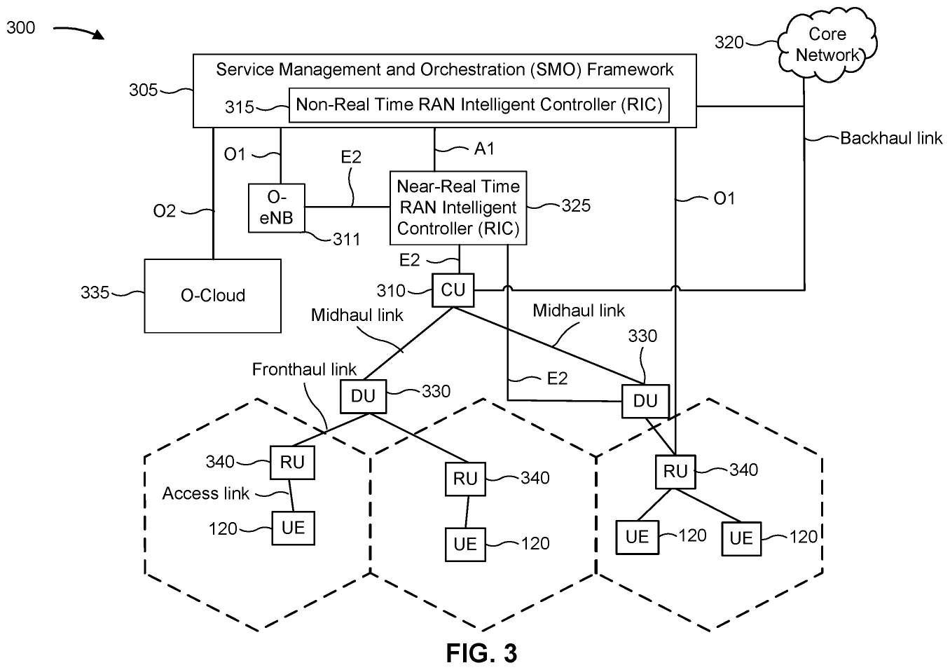

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more RF access links. In some implementations, the UE 120 may be simultaneously served by multiple RUs 340.

Each of the units (e.g., the CUs 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 335) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

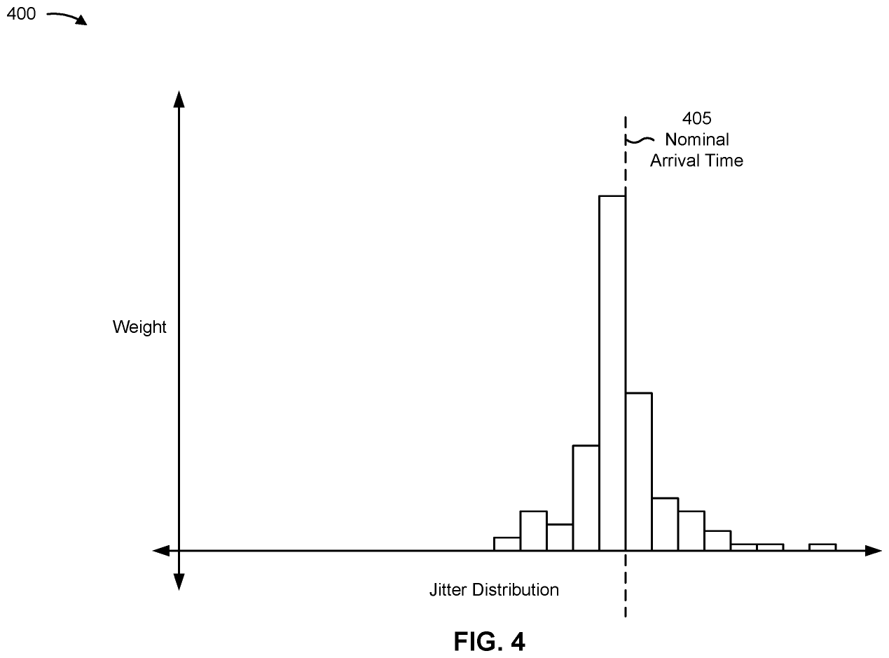

FIG. 4 is a diagram illustrating an example 400 of a jitter distribution, in accordance with the present disclosure. In some communications, data may be received quasi-periodically. For example, a network (e.g., a network node, such as a core network (CN) network node and/or a RAN network node) may receive data that is generally periodic with an offset from a nominal arrival time 405 that is periodic. The nominal arrival time 405 may be associated with a center of a burst arrival time distribution at a user plane function. The nominal arrival time 405 may have a periodicity that is based at least in part on a multimedia periodicity associated with the communications (e.g., a refresh rate of a video stream and/or extended reality (XR) communications, among other examples).

As shown by example 400, some data may be received before the nominal arrival time 405 (e.g., early arrival data) and some data may be received after the nominal arrival time (e.g., late arrival data). In an example, a jitter distribution may have a spread in traffic arrival time of approximately 10 milliseconds (ms) in downlink traffic arrival times for split XR communications (e.g., where rendering processes are performed by a UE and a network node, such as an edge node).

The data may have jitter (e.g., offset from the nominal arrival time 405) based at least in part on a rendering time, an encoder time, and/or a Real Time Transport Protocol (RTP) packetization time at a device generating or forwarding the data (e.g., an application server).

In some networks, XR downlink traffic may have a burst (e.g., set of data packets associated with one or more scenes) arrival time at the network that is quasi-periodic. The jitter of burst arrival time may be equal to approximately 48% of XR periodicity (e.g. 8 ms vs 16.666 ms). In this way, the jitter highly affects an overall XR system performance of capacity and power consumption when using a packet delay budget (PDB) requirement.

An XR client at the UE may have a de-jitter buffer that saves burst packets until a periodic timing for display. In some examples, the PDB requirement may indicate expiration of data packets that may be on-time to the UE (e.g., with reception before the periodic timing for display by an amount of time to allow for processing before display). In this case, the network node may drop the data packets that may have otherwise been used to provide XR data to the UE. This may cause communication errors associated with the XR data, which may consume computing, power, communication, and/or network resources to detect and correct. Additionally, or alternatively, the communication errors may result in a communication configuration that reduces spectral efficiency based at least in part on the network node attempting to correct and/or reduce the errors.

As indicated above, FIG. 4 is provided as an example. Other examples may differ from what is described with regard to FIG. 4.

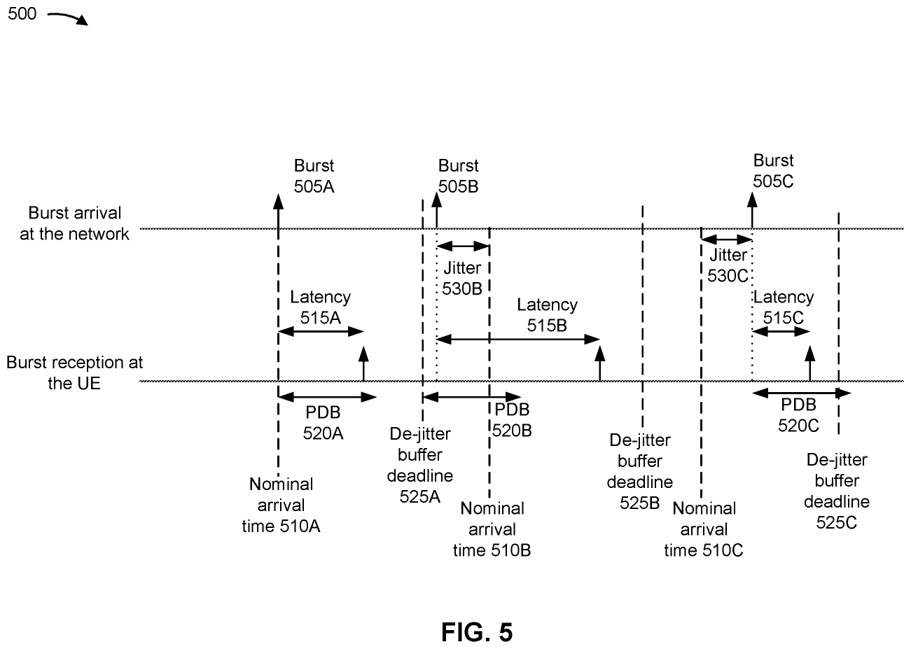

FIG. 5 is a diagram illustrating an example 500 of packet delay budget constraints on jitter-based communications, in accordance with the present disclosure.

As shown in FIG. 5, a burst 505A of data packets may be directed to a UE. The burst 505A may arrive at a network (e.g., a network node, such as a RAN network node and/or a CN network node, among other examples) at a time indicated in FIG. 5 relative to a nominal arrival time 510A. The nominal arrival time 510A may be associated with a periodic arrival time, from which the burst 505A may be offset by a jitter. However, the burst 505A may arrive at the nominal arrival time 510A, with a jitter of zero.

The network may transmit the burst 505A with reception at the UE at a time indicated in FIG. 5. An amount of time between arrival at the network and reception at the UE is a latency 515A. The network may determine whether to transmit the burst 505A based at least in part on whether the latency 515A exceeds a PDB 520A. The PDB 520 indicates an amount of time that the network is able to delay the burst 505A after arrival at the network and before delivery to the UE. If the PDB 520 is exceeded, the network may drop the burst 505A and consider data packets of the burst 505A as expired. The PDB may be established for a communication session associated with the UE and may be a fixed amount of time from arrival at the network.

Based at least in part on the latency 515A satisfying the PDB 520A, the network transmits the burst 505A to the UE. From a perspective of the UE, the UE must receive the burst 505A at or before a de-jitter buffer deadline 525A. The de-jitter buffer deadline 525A may be based at least in part on a display time and an amount of time required by the UE to process the burst 505A before displaying a scene associated with the burst 505A.

A burst 505B may arrive at the network at a time indicated in FIG. 5 relative to a nominal arrival time 510B. The burst 505B may arrive before the nominal arrival time 510B, with a jitter 530B having a negative value to indicate an arrival time that is before the nominal arrival time 510B.

The network may not transmit the burst 505B based at least in part on an expected reception at the UE at a time indicated in FIG. 5 being outside of a PDB 520B. For example, a latency 515B may be greater than the PDB 520. The network may drop the burst 505B and consider data packets of the burst 505B as expired even though the expected reception at the UE being before a de-jitter buffer deadline 525B associated with the burst 505B.

A burst 505C may arrive at the network at a time indicated in FIG. 5 relative to a nominal arrival time 510C. The burst 505C may arrive after the nominal arrival time 510C, with a jitter 530C having a negative value to indicate an arrival time that is after the nominal arrival time 510C.

The network may transmit the burst 505C based at least in part on an expected reception at the UE at a time indicated in FIG. 5 being within the PDB 520C. For example, a latency 515C may be less than the PDB 520. The network may transmit the burst 505B and consider data packets of the burst 505B timely. However, as shown in FIG. 5, the PDB 520C may extend beyond a de-jitter buffer deadline 525C. In this case, the network may transmit the burst 505C after the de-jitter buffer deadline 525C based at least in part on the PDB 520C indicating that the burst 505C is timely. This may consume computing, power, communication, and/or network resources to transmit the burst 505C when the data packets of the burst 505C are expired and will not be rendered for display by the UE.

In some networks, a network may attempt to prevent transmission of expired data to conserve computing, power, communication, and/or network resources. To prevent transmission of the expired data, the network may configure a PDB with a reduced duration to account for a jitter of the data. For example, the network may reduce the duration of the PDB to prevent an amount of time of a jitter and the duration of the PDB from extending from the nominal arrival time 510C past the de-jitter buffer deadline 525C. However, reducing a duration of the PDB may result in an increased number of dropped packets, such as those of burst 505B, that may have otherwise be received at the UE before the nominal arrival time 510B. Additionally, or alternatively, the network may reduce communication capacity to ensure that the PDB is satisfied and that packets are not dropped. However, this may reduce a number of devices that may be supported on a cell of the network.

As indicated above, FIG. 5 is provided as an example. Other examples may differ from what is described with regard to FIG. 5.

In some aspects described herein, a communication session may be associated with a deadline (e.g., a de-jitter buffer deadline) for reception of data packets at a UE. In some aspects, the deadline may replace a PDB that may have otherwise been configured for the data packets. Based at least in part using the deadline, parameters for determining expiration of data packets and/or prioritization of transmission of the data packets may reflect actual timing requirements of the data packets with improved accuracy. In this way, a network node may schedule transmission of the data packets with improved efficiency, without unnecessarily prioritizing the data packets ahead of other data packets that have greater urgency. This may allow the network node to support additional devices in a cell operated by the network node, which may conserve computing, power, communication, and/or network resources that may have otherwise been used to form and/or operate an additional cell to support the additional devices.

In some aspects, the UE may determine timing of the deadline. For example, the UE may determine the deadline (e.g., the de-jitter buffer deadline) based at least in part on a periodic display time (e.g., associated with a refresh rate of multimedia of the communication session) and a device internal data processing time (e.g., 3GPP protocol layer processing time+internet protocol (IP) packet processing time+video decoding time, among other examples). In some aspects, the UE may use a longest processing time of estimated device internal data processing times as a conservative estimate for the deadline. Additionally, or alternatively, the UE may determine the deadline based at least in part on the periodic display time and an internal periodic timer to initiate video decoding.

The deadline may be associated with a packet generation timing adjustment (+/−) between an application server and an application client at the UE with a phase-locked loop at an application layer of the communication session. In this way, at the application layer, the deadline may be set to nominal PDB+Nominal Arrival Time to minimize Motion-to-Render-Photon (M2R2P) latency.

FIG. 6 is a diagram of an example 600 associated with deadline-based data packets, in accordance with the present disclosure. As shown in FIG. 6, multiple network nodes may communicate with a UE (e.g., UE 120). The multiple network nodes may include one or more base stations 110, one or more CUs, one or more DUs, one or more RUs, one or more core network nodes, one or more network servers, one or more application servers, and/or one or more access and mobility management functions (AMFs), among other examples. In some aspects, the UE and a network node (e.g., a RAN network node) of the multiple network nodes may be part of a wireless network (e.g., wireless network 100). The UE and the network node may have established a wireless connection prior to operations shown in FIG. 6.

In some aspects (e.g., as part of establishing the wireless connection) the network node may transmit, and the UE may receive, configuration information. In some aspects, the UE may receive the configuration information via one or more of RRC signaling, one or more MAC control elements (CEs), and/or downlink control information (DCI), among other examples. In some aspects, the configuration information may include an indication of one or more configuration parameters (e.g., already known to the UE and/or previously indicated by the first network node or other network device) for selection by the UE, and/or explicit configuration information for the UE to use to configure the UE, among other examples.

In some aspects, the configuration information may indicate that the UE is to communication in a communication session with a deadline instead of a PDB. The configuration information may indicate that the UE is to provide an indication of the deadline and/or traffic pattern information to the network node. In some aspects, the configuration information may indicate that the UE is to provide traffic pattern information associated with the deadline (e.g., in addition to the deadline or in place of the deadline for the network node to use to derive the deadline, among other examples). In some aspects, the configuration information may indicate that the UE is to transmit an indication that a QoS flow of the communication session is associated with the deadline. In some aspects, the configuration information may indicate that the UE is to receive an indication that the QoS flow of the communication session is associated with the deadline.

The UE may configure itself based at least in part on the configuration information. In some aspects, the UE may be configured to perform one or more operations described herein based at least in part on the configuration information.

As shown by reference number 605, the UE, the network node, a CN network node, and/or an application server may establish a QoS flow that is deadline-based. For example, the UE, the network node, the CN network node and/or the application server may establish a connection and/or parameters for communicating via the communication session. In some aspects (e.g., as part of establishing the QoS flow), the network node may indicate to the UE that the QoS flow is associated with the deadline and is not associated with a packet delay budget. In some aspects (e.g., as part of establishing the QoS flow), the UE may indicate to the network node that the QoS flow is associated with the deadline and is not associated with a packet delay budget. In some aspects, the CN network node and/or the application server may indicate to the network node that the QoS flow is associated with the deadline, is not associated with a packet delay budget and/or that expiration of the data packets of the communication session is associated with the deadline, and is not associated with a packet delay budget. In some aspects, the network node may transmit an indication (e.g., to the UE) that expiration of the data packets of the communication session is associated with the deadline and is not associated with a packet delay budget.

In some aspects, the deadline is based at least in part on a periodic display time and a UE internal data processing time. For example, the deadline may be offset from the periodic display time by an amount that is equal to or greater than the UE internal data processing time. In some aspects, the periodic display time may be associated with display of a scene of a video feed, such as an XR video feed, among other examples.

In some aspects, the UE may receive (e.g., as part of establishing the QoS flow), an indication of a mapping of QoS flows to IP flows. The mapping may be used to translate an IP flow a QoS flow for indicating that the deadline applies to the QoS flow.

As shown by reference number 610, the UE may receive, from an app client (e.g., an application client of the UE or an application client of a connected device, among other examples), information indicating a deadline and/or traffic pattern information of the QoS flow. In some aspects, the information may indicate a deadline (e.g., de-jitter buffer deadline), a periodicity, a nominal packet delay budget, a jitter of burst arrival times, and/or a nominal arrival time of data packets of the communication session among other examples.

In some aspects, the UE may identify a burst index of the data packets based at least in part on burst metadata available at an application layer of the data packets and/or a determined burst index based at least in part on timing of the data packets. In some aspects, the deadline is periodic, and the burst index is associated with an occasion of the deadline.

As shown by reference number 615, the UE may convert the deadline to a RAN time domain. For example, the UE may convert the deadline from a time relative to an application associated with the QoS flow or an absolute time to a RAN time domain unit, such as a subframe number and/or a slot number, among other examples. In some aspects, the UE may convert the deadline into a RAN time domain comprises converting the deadline from an application time domain to the RAN time domain based at least in part on deadline mapping associated with a quality of service (QoS) flow, one or more deadline notification messages, and/or one or more data radio bearer (DRB) QoS parameters associated with the deadline, among other examples. In some aspects, the UE may receive the deadline mapping, the deadline notification messages, and/or the DRB QoS parameters during or after establishing the QoS flow described in connection with reference number 605 and/or via the application client, among other examples.

As shown by reference number 620, the UE may identify an IP flow and/or the QoS flow to which the deadline applies. For example, the UE may be aware of the IP flow associated with the deadline based at least in part on the communication session and/or the data packets being associated with the IP flow via the application client. In some aspects, the UE may use an IP flow to QoS flow mapping to identify the QoS flow from the IP flow. In some aspects, the UE may identify an IP flow to which the deadline applies based at least in part on an indication of the IP flow via an application layer of the data packets and/or a determined logical channel identification based at least in part on an IP packet index of the data packets, among other examples.

As shown by reference number 625, the UE may transmit, and the network node may receive, an indication of the deadline and/or traffic pattern information (e.g., additional traffic pattern information) and/or an indication that the QoS flow is associated with the deadline. In some aspects, traffic pattern information may include a nominal packet delay budget, a jitter of burst arrival times, or a nominal arrival time of data packets of a communication session associated with the QoS flow. In some aspects, the deadline may include a converted deadline (e.g., converted from application-based time or absolute time to a RAN time, such as a subframe number and/or slot number, among other examples).

In some aspects, the UE may transmit additional or alternative information. For example, the UE may transmit an indication that a QoS flow or logical channel associated with the data packets is associated with the deadline, an indication of a burst index associated with an occasion of the deadline, and/or an indication that a logical channel identification associated with the data packets is associated with the deadline, among other examples.

In some aspects, the UE may receive an additional indication that the QoS flow or logical channel is configured with the deadline and transmitting an indication that the QoS flow or logical channel associated with the data packets is associated with the deadline. For example, the network node may indicate that the QoS flow is a deadline-based QoS flow. In some aspects, the network node may indicate that the network node is informed of the deadline based at least in part on receiving the traffic pattern information and/or an indication of a jitter of the QoS flow from the CN network node, the application server, and/or the UE, among other examples.

In some aspects, the UE may transmit the indication of one or more of the deadline, the periodicity, the nominal packet delay budget, the jitter of burst arrival times, or the nominal arrival time of data packets of the communication session via an RRC message, a MAC CE, and/or an application layer indication, among other examples.

In some aspects, the UE may transmit the indication of the deadline and/or the traffic pattern information to a CU of the network (e.g., the network node or a component of the network node). The CU may forward the deadline and/or the traffic pattern information to a DU of the network (e.g., the network node or a component of the network node). In some aspects, the CU may use the traffic information to derive the deadline and may forward the deadline to the DU.

As shown by reference number 630, the network node may receive, and the CN network node may provide, traffic pattern information and/or an indication of jitter associated with the QoS flow. In some aspects, the traffic pattern information may include the periodicity, the nominal packet delay budget, the jitter of burst arrival times, and/or the nominal arrival time of data packets of the communication session, among other examples. In some aspects, the network node may derive the deadline based at least in part on the traffic pattern information and/or the jitter.

In some aspects, the network node may receive the traffic pattern information from the CN network node as an alternative from receiving the traffic pattern information from the UE. In some aspects, the network node may receive one or more information elements of the traffic pattern information from the CN network node one or more additional information elements of the traffic pattern information from the UE.

In some aspects, the network node may receive the indication of the jitter via a user plane header. For example, the network node may receive the indication of the jitter in a general packet radio service (GPRS) tunnelling protocol user plane (GTP-U) header. In some aspects, the jitter is based at least in part on an actual burst arrival time at the network and a nominal arrival time associated with the data packets. In this way, the jitter may indicate a deadline occasion to which the data packets belong. For example, a positive jitter may indicate that the data packets may be close to the deadline. Alternatively, a negative jitter may indicate that the data packets are early and are not close to the deadline (e.g., if the data packets are close to a deadline, apply a subsequent occasion of the deadline to the data packets).

As shown by reference number 635, the network node may receive data packets from the application server (e.g., via the CN node). In some aspects, the data packets may be associated with the QoS flow and may be addressed to the UE.

As shown by reference number 640, the network node may identify a deadline and/or burst groups, and/or may drop data packets. In some aspects, the network node may identify the deadline based at least in part on receiving an indication of the deadline or based at least in part on deriving the deadline using the traffic pattern information received via the UE and/or the CN network node, among other examples. In some aspects, the network node may identification the deadline based at least in part on one or more of the periodicity, the nominal packet delay budget, the jitter of burst arrival times, and/or the nominal arrival time of data packets. For example, the network node may derive the deadline and/or may determine an occasion of the deadline to apply to the data packets.

In some aspects, the network node may identify a deadline occasion associated with the data packets. For example, the deadline may be periodic, such that a data packet received late for a first deadline occasion may be received before a second deadline occasion. The network node may first identify which deadline occasion applies to the data packets and then determine whether the data packets are timely (e.g., satisfy the deadline).

In some aspects, the network node may drop data packets based at least in part on failing to satisfy the deadline. For example, the network node may drop data packets that the network node is unable to schedule for transmission to the UE before or at the deadline.

In some aspects, the network node may identify a deadline that applies to the data packets based at least in part on a burst group of the data packets. For example, the network node may group data packets into a burst group based at least in part on the indication of the deadline, a periodicity, a nominal packet delay budget, the jitter of burst arrival times, or the nominal arrival time of data packets of the communication session. For example, the network node may group data packets into a group associated with a deadline based at least in part on receiving the data packets within a threshold amount of time from the nominal arrival time and/or one or more deadlines (e.g., a previous deadline, the deadline, and/or a subsequent deadline).

As shown by reference number 645, the UE may receive, and the network node may transmit an indication of a downlink resource for receiving the data packets of the QoS flow, an indication of acceptance of the deadline, and/or an indication of the QoS or logical channel identification (LCID) associated with the deadline. In some aspects, the downlink resource may be based at least in part on the indication of the deadline, the periodicity, the nominal packet delay budget, the jitter of burst arrival times, and/or the nominal arrival time of data packets of the communication session. For example, the network node may schedule the downlink resource to satisfy the deadline. In this way, the network node may prioritize the data packets appropriately while allowing transmission of additional data packets that may have a greater urgency.

In some aspects, the network node may transmit an indication that the network node accepts the deadline and/or one or more traffic pattern information elements, such as the periodicity, the nominal packet delay budget, the jitter of burst arrival times, or the nominal arrival time of data packets of the communication session.

In some aspects, the network node may indicate to the UE that a QoS flow or logical channel associated with the data packets is associated with the deadline, an indication of a burst index associated an occasion of the deadline, and/or an indication that an LCID associated with the data packets is associated with the deadline.

In some aspects, the network node may transmit an additional indication that the QoS flow or logical channel is configured with the deadline based at least in part on receiving the indication that the QoS flow or logical channel associated with the data packets is associated with the deadline. For example, the network node may confirm that the QoS flow is configured to use the deadline based at least in part on receiving the indication that the QoS flow is associated with the deadline (e.g., from the UE, the application server, and/or the CN network node, among other examples).

In some aspects, in preparation and/or in a determination to transmit the data packets, the network node may identify the QoS associated with the data packets, apply the deadline to the data packets based at least in part on the QoS flow being associated with the deadline, and/or apply a periodic occasion of the deadline to the data packets based at least in part on a time at which the network node receives the data packets or an indication of a burst number of the data packets.

As shown by reference number 650, the UE may receive, and the network node may transmit, the data packets of the QoS flow. In some aspects, the UE may receive, and the network node may transmit, the data packets based at least in part on the reception time and/or expected reception time of the data packets satisfying (e.g., being at or before) the deadline.

Based at least in part using the deadline, parameters for determining expiration of data packets and/or prioritization of transmission of the data packets may reflect actual timing requirements of the data packets with improved accuracy. In this way, a network node may schedule transmission of the data packets with improved efficiency, without unnecessarily prioritizing the data packets ahead of other data packets that have greater urgency. This may allow the network node to support additional devices in a cell operated by the network node, which may conserve computing, power, communication, and/or network resources that may have otherwise been used to form and/or operate an additional cell to support the additional devices.

As indicated above, FIG. 6 is provided as an example. Other examples may differ from what is described with respect to FIG. 6.

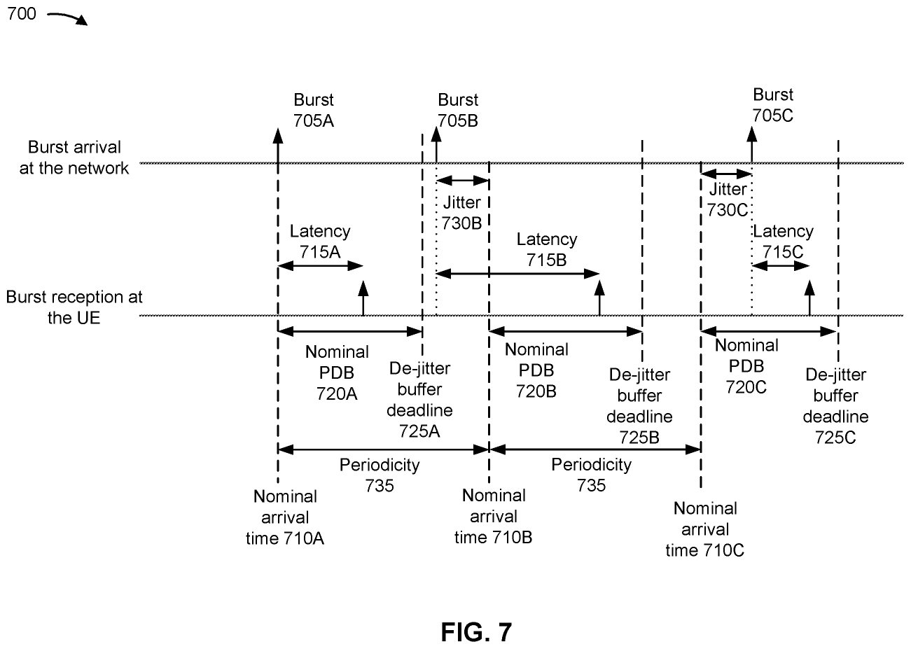

FIG. 7 is a diagram of an example 700 associated with deadline-based data packets, in accordance with the present disclosure. As shown in FIG. 7, a UE (e.g., UE 120) may communication with a network (e.g., with one or more network nodes of the network). The network may include one or more base stations 110, one or more CUs, one or more DUs, one or more RUs, one or more core network nodes, one or more network servers, one or more application servers, and/or one or more AMFs, among other examples. In some aspects, the UE and a network node (e.g., a RAN network node) of the multiple network nodes may be part of a wireless network (e.g., wireless network 100). The UE and the network node may have established a wireless connection prior to operations shown in FIG. 7.

As shown in FIG. 7, a burst 705A of data packets may be directed to a UE. The burst 705A may arrive at a network (e.g., a network node, such as a RAN network node and/or a CN network node, among other examples) at a time indicated in FIG. 7 relative to a nominal arrival time 710A. The nominal arrival time 710A may be associated with a periodic arrival time, from which the burst 705A may be offset by a jitter. However, the burst 705A may arrive at the nominal arrival time 710A, with a jitter of zero.

The network may transmit the burst 705A with reception at the UE at a time indicated in FIG. 7. An amount of time between arrival at the network and reception at the UE is a latency 715A. A nominal PDB 720A may be an amount of time between the nominal arrival time 710 and a de-jitter buffer deadline 725A before or during which the network node may transmit the burst 705A to the UE without failing to satisfy the de-jitter buffer deadline 725A.

The network may determine whether to transmit the burst 705A based at least in part on whether the network node can transmit the burst 705A such that the UE receives the burst 705A at or before the de-jitter buffer deadline 725A. If the de-jitter buffer deadline 725A is missed, the network may drop the burst 705A and consider data packets of the burst 705A as expired.

Based at least in part on the latency 715A satisfying the de-jitter buffer deadline 725A, the network transmits the burst 705A to the UE. From a perspective of the UE, the UE must receive the burst 705A at or before a de-jitter buffer deadline 725A. In this way, the same deadline (e.g., the de-jitter buffer deadline 725A) is applied to the data packets at the network and at the UE. The de-jitter buffer deadline 725A may be based at least in part on a display time and an amount of time required by the UE to process the burst 705A before displaying a scene associated with the burst 705A.

A burst 705B may arrive at the network at a time indicated in FIG. 7 relative to a nominal arrival time 710B. The burst 705B may arrive before the nominal arrival time 710B, with a jitter 730B having a negative value to indicate an arrival time that is before the nominal arrival time 710B.

The network may transmit the burst 705B based at least in part on an expected reception at the UE at a time indicated in FIG. 7 being at or before the de-jitter buffer deadline 725B and/or the nominal PDB 720B. For example, a latency 715B may not control whether the network node transmits the data packets, even if the latency 715B is greater than the nominal PDB 720B.

A burst 705C may arrive at the network at a time indicated in FIG. 7 relative to a nominal arrival time 710C. The burst 705C may arrive after the nominal arrival time 710C, with a jitter 730C having a negative value to indicate an arrival time that is after the nominal arrival time 710C.

The network may transmit the burst 705C based at least in part on an expected reception at the UE at a time indicated in FIG. 7 being at or before the de-jitter buffer deadline 725C and/or the nominal PDB 720C. In some aspects, the network node may transmit the burst 705C with a relatively short latency 715C to satisfy the de-jitter buffer deadline 725C. For example, the network node may prioritize the burst 705C to transmit the burst 705C at or before the de-jitter buffer deadline 725C.

The nominal arrival times 710 are associated with a periodicity 735. The periodicity 735 may be based at least in part on an application associated with the data packets. For example, the periodicity 735 may be associated with a refresh rate of a video feed.

As indicated above, FIG. 7 is provided as an example. Other examples may differ from what is described with regard to FIG. 7.

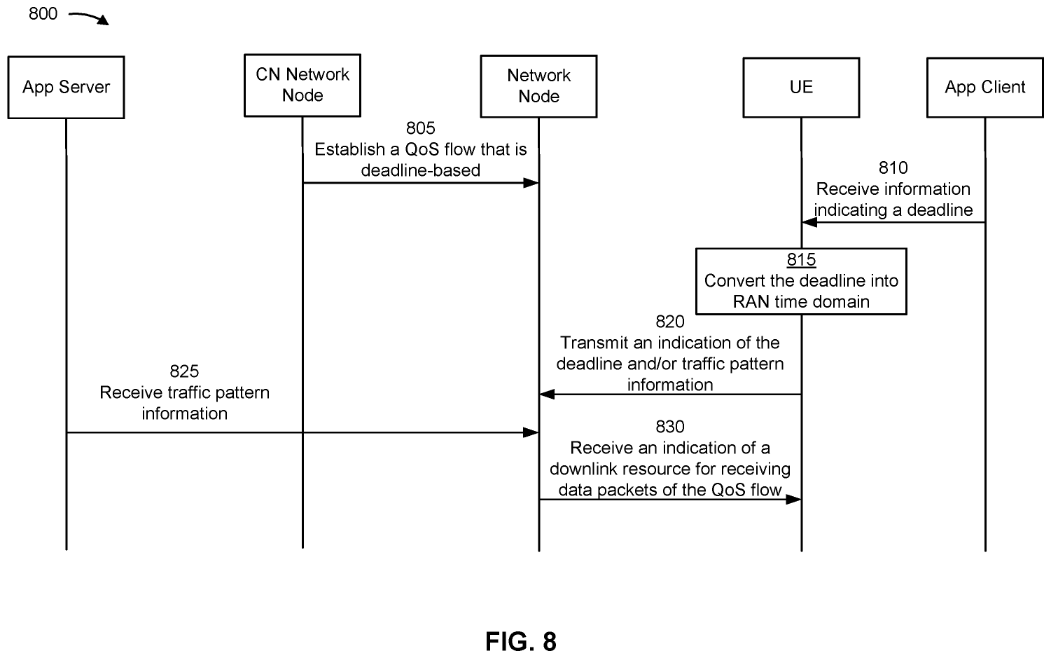

FIG. 8 is a diagram of an example 800 associated with deadline-based data packets, in accordance with the present disclosure. As shown in FIG. 8, multiple network nodes may communicate with a UE (e.g., UE 120). The multiple network nodes may include one or more base stations 110, one or more CUs, one or more DUs, one or more RUs, one or more core network nodes, one or more network servers, one or more application servers, and/or one or more AMFs, among other examples. In some aspects, the UE and a network node (e.g., a RAN network node) of the multiple network nodes may be part of a wireless network (e.g., wireless network 100). The UE and the network node may have established a wireless connection prior to operations shown in FIG. 8.

As shown by reference number 805, the CN network node may establish a QoS flow that is deadline-based. For example, the CN network node (e.g., the 5G core network) may set a new “QoS flow with deadline” in a PDU session. The QoS flow may define a deadline instead of a PDB.

For a QoS flow with a deadline, the UE may define its own deadline by indicating the timing to the network node, or the deadline may eventually converge to a nominal arrival time+nominal PDB. In some aspects, a 5G QoS flow table may include a new information element that indicate packet delivery requirement of ‘deadline’ instead of ‘PDB.’ For example, the deadline may be defined with PDU set design parameters such as a PSDB (e.g., an application data unit (ADU) delay budget (ADB)) and/or a PDU set error rate (PSER) (e.g., an ADU error rate (AER).

In some aspects, the CN network node may decide which IP flow is set for QoS flow with deadline (e.g., using Policy Control Function (PCF)/Session Management Function (SMF)). In some aspects, the CN network node may indicate to the network node which QoS flow is set for deadline during a PDU session establishment. In some aspects, the CN network node may indicate to the UE which QoS flow is set for deadline with a non-access stratum (NAS) message. Additionally, or alternatively, the network node may indicate to the UE which LCID is set for deadline with an RRC message.

In some aspects, related information elements in a communication standard may be extended. For example, [CN to NAS] N11/N2 interfaces+F1/E1 interfaces (e.g. PDU session—QoS Parameters); [CN to UE] NAS messages (e.g. indicate QoS flow for deadline); and/or [gNB to UE] RRC messages (e.g. indicate LCID for deadline).

As shown by reference number 810, the application client may provide, and the UE may receive, information indicating the deadline. In some aspects, the application client may provide the information indicating the deadline using an application layer indication (e.g., an X-layer Application Programming Interface (API)). In some aspects, the UE and/or the application client may not need to indicate a burst index and/or PDU set index in example 800.

In some aspects, the application layer indicates the deadline of an IP flow to a modem of the UE with an X-layer API (e.g., to translate an application deadline into a deadline that the network node understands).

The application client may indicate specific timing of a UE internal clock for the deadline. The application client calculates the deadline from a de-jitter buffer timing and translates it to UE clock timing. Clocks of the modem of the UE and the application client may be different, thus the application client may need to map (e.g., continuously or periodically map) the UE clock timing and application timing to compensate for a clock drift.

The application client may indicate a burst index (or PDU set index) and/or an internal IP packet index to the UE. For example, the application client may indicate which burst index is associated with the deadline. If burst metadata (or PDU set metadata) is available at the application layer, the application client may explicitly indicate the burst index to the UE. If the burst metadata is unavailable at the application layer, the application client may provide an IP packet index of the deadline, which may be internally assumed between the UE and the application client, and the UE may translate the IP packet index to a burst index (or PDU set index). A Uu interface may be used to provide the burst metadata (or PDU set metadata) index to the UE, and the UE may need to keep the mapping information between burst index (or PDU set index) and the IP packet index.

The application client may provide an indication of an IP flow or an internal IP packet index. For example, the application layer may indicate which IP flow (e.g. IP 5-tuple) is associated with the deadline. In another example, the application layer may provide an IP packet index and the UE may translate the IP packet index to an associated LCID.

The application client may indicate a traffic pattern and requirement. In some aspects, instead of eTSCAI (application server to network node), the application server may indicate the traffic pattern and requirement (e.g., periodicity, nominal PDB, nominal arrival time, among other examples) to the application client, and the UE sends all information related to the deadline to the network node.

As shown by reference number 815, the UE may convert the deadline into a RAN time domain. In some aspects, the UE may convert the deadline using a deadline mapping with the QoS flow (e.g., X-layer API). In some aspects, the UE may use a deadline notification message (e.g., a 3GPP-RRC message). In some aspects, the UE may use DRB QoS parameters for the deadline (e.g., a deadline key performance indicator (KPI)).

In some aspects, the application layer does not know information of the QoS flow, thus the UE may need to provide an indication of the QoS flow to the network node. In some aspects, the UE is provided with a packet filter for an uplink direction with an NAS message, but the UE may not know a packet filter for the downlink direction. In some aspects, the network (e.g., CN network node) may provide the information of uplink and downlink packet filters to the UE with an NAS message (mapping relationship between IP flows and QoS flows). In some aspects, the network may indicate a packet filter with traffic flow template (TFT) or service data flow (SDF) templates. For example, the network may indicate a packet filter that typically consists of an IP 5-tuple={source IP, destination IP, source Port, destination Port, Protocol ID}. Based at least in part on the DL TFT, the UE translates an IP flow to a QoS flow.

As shown by reference number 820, the UE may transmit, and the network node may receive, an indication of the deadline and/or traffic pattern information. In some aspects, the UE may transmit the indication of the deadline and/or the traffic pattern information via an RRC message. For example, the UE may transmit a message with information elements indicating deadline notification: deadline, burst index, and/or QoS flow or LCID.

In some aspects, the UE may have multiple flows so the UE may need to specify which QoS flow has the deadline. In some aspects, for QoS mapping in a downlink direction, the CN SMF (NAS level) may indicate the mapping using an IP flow to QoS flow (packet filter, TFT), a network node may use an SDAP layer (access stratum (AS) level) to indicate a QoS flow to DRB (n:1 mapping), and/or a network node may use a RLC layer to indicate DRB to LCID (1:1 mapping).

In some aspects, the UE may indicate the deadline of a burst (or PDU set) to the network node using a MAC CE command or an RRC message. For example, with a MAC CE command, the deadline is directly related to scheduling of the MAC layer (e.g. deadline-based scheduling). Using an RRC message, the network node may negotiate timing of the deadline between the UE and the network node with an RRC protocol.

In some aspects, the indication of the deadline of a burst (e.g., PDU set) may include one or more protocol information elements. For example, the indication may include the deadline (e.g., translated to 5G system clock), a burst index (PDU set index), and/or a QoS flow or LCID. The deadline indication may indicate specific timing of the deadline in a RAN system clock. For example, the UE translates the deadline timing that is indicated by the application client in the UE internal clock to the RAN system clock. The UE may need a time-synchronization between the application client and the UE for this translation. In some aspects, the time in the RAN system clock may include a subframe number (SFN) (e.g., latest or partial bits), a subframe index (e.g., 10-bit, ms), and/or a slot index. Additionally, or alternatively, the time in the RAN system clock may include an SFN reference time (e.g., latest or partial bits), a time difference between the SFN reference time, and the deadline (e.g., ms or microseconds)

The indication of the burst index (or PDU set index) may indicate which burst (or PDU set) has the specific timing of the deadline. If the application layer does not have the explicit burst index, the UE may translate the IP packet index to the burst index (or PDU set index)

The indication of the QoS Flow or LCID may include the UE indicating which QoS flow has the deadline. For example, the UE may translate an IP flow indicated by the application client to a QoS flow. Additionally, or alternatively, the UE may indicate which LCID has the deadline. In this way, the RAN can handle the deadline without any information from an upper layer. However, all QoS flows in an LCID may have the same deadline requirement.

In some aspects, the network node may respond to the indication of the deadline and/or the traffic pattern information with an indication of acceptance or rejection. In some aspects, deadlines provided by individual UEs may not be acceptable at the network node side, so the network node may negotiate the deadline with the UE.

If the deadline is not acceptable at the network node side, the network node may send a rejection message to the UE. In some aspects, the network node may provide a negotiated deadline to the UE. Additionally, or alternatively, if the deadline is rejected, the UE may need to adjust a display timing based at least in part on an updated deadline.

In some aspects, the UE may transmit the indication of the deadline and/or the traffic pattern to a CU (e.g., the network node or a component of the network node). The CU may provide the indication of the deadline and/or the traffic pattern to a DU. In some aspects, the CU may use a new DRB QoS parameter to indicate the deadline over an F1 interface (CU to DU). For example, the DU may indicate provide the indication using an information flow, such as UE context to DRB to QoS flow level QoS parameters to dynamic 5G QoS identifier (5QI) descriptor. In some aspects, the CU may specify the deadline timing to the DU with a dynamic descriptor. In some aspects, the CU may mark that this QoS flow is associated with the deadline, and indicate the deadline timing. In some aspects, the DU may can send back to the CU an accept or reject message.

As shown by reference number 825, the network node may receive traffic pattern information from the application server. For example, the network node may receive periodicity and/or nominal PDB from the application server. In some aspects, the network node may use an enhanced TSCAI to provide the nominal PDB and periodicity to the network node (e.g., application function to network node). Alternatively, the UE may provide all of the traffic pattern information to the network node.

In some aspects, the network node may determine bursts of data packets using implicit burst packet grouping for the deadline (e.g., for a deadline KPI). In some aspects, the network node may need to identify which IP packets belong to the n-th burst (or PDU set). The UE may check the QoS flow of packets as to apply the deadline only for relevant QoS flows. Based at least in part on burst timing information (deadline, nominal PDB, periodicity), the network node may identify packets that are delivered within the following time period as part of the n-th burst:

n-th deadline−nominal PDB+n*periodicity+/−periodicity/2

N-th burst packets may be required to be delivered within the n-th deadline. For example, for a CN UPF solution, a CN UPF (e.g., the CN network node) marks the burst packets using a UPF. The CN UPF identifies the burst packets based at least in part on packet arrival timings to UPF, and the CN UPF marks the burst in a GTP-U header. The CN UPF indicates the burst packets to the network node CU over an N3 interface (e.g., using a GTP-U header). The network node CU indicates the burst packets to a network node DU over an F1-U interface (e.g., using a GTP-U header)

In some aspects, the network node may mark the burst packets using PDCP. The network node DU may identify the burst packets based at least in part on the packet arrival timings to the network node CU, and the DU or the CU may mark the burst in a GTP-U header. The network node CU indicates the burst packets to the network node DU over an F1-U interface (e.g., using a GTP-U header).

In some aspects, the network node DU may use a MAC layer indication to identify the burst packets by itself. The network node DU identifies the burst packets based at least in part on the packet arrival timings to network node DU by itself. The LCID indicates which packet flows are related to the deadline.

As shown by reference number 830, the UE may receive, and the network node may transmit, an indication of a downlink resources for receiving data packets of the QoS flow. In some aspects, the network node may schedule traffic for the data packets (e.g., XR traffic) based at least in part on the deadline. In some aspects, the network node may perform implicit burst packet grouping. For example, the network node may group data packets in to burst based at least in part on a deadline, a nominal PDB and/or a periodicity (e.g., deadline−nominal PDB+n*periodicity+/−periodicity/2).

In some aspects, the network node may schedule the data packets arriving during [deadline−nominal PDB+n*periodicity+/−periodicity/2] for transmission by deadline+n*periodicity. In some aspects, the network node may use [3GPP-burst packet] to implicitly group bursts of data packets (e.g., implicit burst packet grouping) for deadline KPI. In some aspects, data packets delivered within the periodicity is assumed as a set of burst packets.

As indicated above, FIG. 8 is provided as an example. Other examples may differ from what is described with regard to FIG. 8.

FIG. 9 is a diagram of an example 900 associated with deadline-based data packets, in accordance with the present disclosure. As shown in FIG. 9, multiple network nodes may communicate with a UE (e.g., UE 120). The multiple network nodes may include one or more base stations 110, one or more CUs, one or more DUs, one or more RUs, one or more core network nodes, one or more network servers, one or more application servers, and/or one or more AMFs, among other examples. In some aspects, the UE and a network node (e.g., a RAN network node) of the multiple network nodes may be part of a wireless network (e.g., wireless network 100). The UE and the network node may have established a wireless connection prior to operations shown in FIG. 9.

As shown by reference number 905, a CN network node and the network node may establish a QoS flow that is deadline-based. For example, the CN network node (e.g., the 5G core network) may set a new “QoS flow with deadline” in a PDU session. The QoS flow may define a deadline instead of a PDB.

For a QoS flow with a deadline, the UE may define its own deadline by indicating the timing to the network node, or the deadline may eventually converge to a nominal arrival time+nominal PDB. In some aspects, a 5G QoS flow table may include a new information element that indicate packet delivery requirement of ‘deadline’ instead of PDB. For example, the deadline may be defined with PDU set design parameters such as ADB and AER.

In some aspects, the CN network node may decide which IP flow is set for QoS flow with deadline (e.g., using PCF/SMF). In some aspects, the CN network node may indicate to the network node which QoS flow is set for deadline during a PDU session establishment. In some aspects, the CN network node may indicate to the UE which QoS flow is set for deadline with an NAS message. Additionally, or alternatively, the network node may indicate to the UE which LCID is set for deadline with an RRC message.

In some aspects, related information elements in a communication standard may be extended. For example, CN to NAS N11/N2 interfaces and F1/E1 interfaces (e.g., for a PDU session having QoS parameters); CN to UE NAS messages (e.g., to indicate a QoS flow for deadline); and/or network node to UE RRC messages (e.g., to indicate an LCID for a deadline).

As shown by reference number 910, the CN network node may receive traffic pattern information from an application server. For example, an application function of the application server may provide XR traffic pattern information (e.g., periodicity, nominal PDB, nominalArrivalTime) to the CN network node. The application server may provide the XR traffic pattern information using an Nx interface to transmit an enhanced TSCAI or another message. Alternatively, the UE may provide the information to the network node. In some aspects, the CN network node and the network node may need to be synchronized to use the NominalArrivalTime to determine the deadline.

As shown by reference number 915, the network node may receive an indication of jitter of the QoS flow. In some aspects, the CN network node (e.g., using a user plane function) may mark jitter in a GTP-U header using metadata of a burst in an N3/F1 interface. For example, the GTP-U header may indicate jitter of a burst arrival time. In some aspects, the CN network node (e.g., the UPF) may mark the jitter of burst arrival time for each burst in the GTP-U header.

In some aspects, the CN UPF calculates the jitter of burst arrival time, and marks the GTP-U header with the jitter. In some aspects, the jitter of burst arrival time=Actual burst Arrival Time−Nominal Arrival Time. The CN UPF may indicate the jitter of burst arrival time to the network node CU over an N3 interface. The network node CU may indicate jitter information to the network node DU over an F1 interface.

The indication may be a new information element ‘Jitter of burst Arrival Time’ in the GTP-U header (N3/F1 interface). The CN UPF may provide the jitter of burst arrival time of a current burst (or PDU set) to the network node. To reduce an amount of information bits, the jitter may be digitized (e.g., mean square betweens (MSBs) of a jitter amount). A GTP-U may be extended to adopt an indication of a burst or PDU set (e.g., burst index, PDU set index), and the jitter information may be added on the top of the indication of the burst or PDU set.

In some aspects, the application server and the CN network node (e.g., the CN UPF) may need to be time-synchronized to calculate the jitter.

As shown by reference number 920, the UE may receive, and the network node may transmit, an indication of a downlink resource for receiving data packets of the QoS flow. In some aspects, the network node may use implicit burst packet grouping to correlate bursts with the deadline and/or occasions of the deadline.

In some aspects, the network node may schedule the downlink resource based at least in part on a deadline associated with data packets. For example, data packets arriving during [deadline−nominal PDB+n*periodicity+−periodicity/2] should be delivered by deadline+n*periodicity. Additionally, or alternatively, the network node may perform implicit burst packet grouping based at least in part on arrival times of the data packets.

As indicated above, FIG. 9 is provided as an example. Other examples may differ from what is described with regard to FIG. 9.

In some aspects, a network may be configured to use a nominal PSDB for identifying a deadline for transmission of a PDU set. For example, the network may configure the nominal PSDB (e.g., a nominal PDB for a PDU set) for a flow (e.g., a data flow and/or a QoS flow, among other examples). The nominal PSDB may be a reference delay budget associated with the flow. For example, the nominal PSDB may indicate a delay budget of a PDU set, with the delay measured from a nominal arrival time to arrival at the UE.

In some aspects, an application server may indicate a jitter of a PDU set along with the PDU set. For example, the application server may indicate the jitter within a header (e.g., an application layer header or an RTP header, among other examples). In some aspects, the application server may determine a deadline for transmitting the PDU set based at least in part on an offset from the nominal PSDB, with the offset being based at least in part on the jitter of the PDU set.

In some aspects, the network node may receive (e.g., from the application server and/or an additional network node, such as a CN network node, among other examples) an indication of a specific value of a nominal PSDB that includes any offset from jitter.

In some aspects, the application server may explicitly indicate the jitter of a generation time (e.g., PDU set generation and/or burst generation) within metadata of the PDU set. For example the application server may indicate the jitter in a PDU set header, such as an application layer header of the PDU set. The jitter of the generation time may be based at least in part on a render time, an encoder time, and/or an RTP packetization time. Based at least in part on the application server indicating the jitter, the application server, a CN network node (e.g., a user plane function (UPF) entity), and/or the network node are not required to be time-synchronized for communicating the deadline for transmission. Additionally, or alternatively, the network node may not be required to obtain flow traffic pattern information, such as periodicity or arrival time, associated with the PDU set.

The network node may account for jitter and the nominal PSDB when scheduling the PDU set for transmission. For example, the UE may use a dynamic PSDB, to set a deadline for transmission, that is based at least in part on the nominal PSDB with an offset (e.g., positive or negative) that is based at least in part on the jitter of the PDU set.

In some aspects, a CN network node may set a QoS flow with a nominal PSDB in a PDU session. For example, the CN network node may set a new QoS identifier (QI) to define a nominal PSDB in place of a legacy PDB. In some aspects, the CN network node may set a non-dynamic QI as a representative value of nominal PSDB that is pre-defined in a QoS flow table. In some aspects, the CN network node may provide a dynamic QI with a specific value of nominal PSDB that accounts for jitter for a particular PDU set.

In some aspects, an application server provides an indication of jitter in a PDU set header. The application server may attempt to set a nominal arrival time (e.g., based at least in part on a time of transmitting the PDU set to the network) with an offset from a deadline (e.g., de-jitter buffer deadline) that is equal to or greater than a nominal PDB (e.g., a nominal PSDB).

The network node may consider (e.g., account for) the jitter indicated in the PDU set header and the nominal PSDB hen scheduling the PDU set. For example, the network node may use MAC scheduling with a dynamic PSDB determined as a difference between a nominal PSDB and the jitter of the PDU set. The network node may schedule the PDU set (e.g., XR traffic) based at least in part on the dynamic PSDB. In some aspects, the deadline for transmission of the PDU set is associated with an end of the dynamic PSDB.

In some aspects, the application server may indicate the jitter (e.g., dynamic jitter) in a PDU set header (e.g. using an RTP protocol). The application server may directly provide the jitter of the PDU set in a PDU set header. To improve latency, the application server and/or a network node (e.g., a CN network node) may set a deadline for transmission of the PDU set to nominal arrival time plus a nominal PDB (e.g., nominal PSDB). In some aspects, the application server may indicate the jitter in a GTP-U header. For example, a UPF may relay the jitter and/or other information of the PDU set to the network node via an N1 and/or F1 interface using a GTP-U (e.g., enhanced GTP-U) header.

In some aspects, when a flow is established having a nominal PSDB, the network node may be configured to account for a dynamic jitter of PDU sets. For example, the network node may be configured to account for the jitter indicated in an application layer header of the PDU sets based at least in part on a CN network node indicating to the network node that a field for PDB is used to indicate a nominal PSDB. A PCF and/or an SMF may provide an indication to use a PSDB to an AMF, which may provide the indication to an access node (AN), which may provide the indication to a network node (e.g., RAN network node) CU (e.g., via an N11/N2 interface). The network node CU may provide the indication to a network node DU e.g., (via an F1 interface). In this way, the network node DU may know which QoS flow associated with the network node DU has the nominal PSDB.

In some aspects, the CN network node may identify a maximum jitter allowed for a QoS flow with a nominal PSDB. In some aspects, the application server is not allowed to provide the jitter with a value that exceeds (e.g., in a negative or positive direction) the maximum allowed jitter. In some aspects, if the dynamic jitter provided by the application server provides exceeds the maximum allowed jitter, the network node may truncate the dynamic jitter to the maximum jitter. In some aspects, the CN network node may indicate, to the application server and/or the network node, the maximum allowed jitter.

In some aspects, if the jitter is not provided with the PDU set (e.g., in a header or other metadata), the network node and/or the CN network node may apply a default value for the jitter. For example, the network node and/or the CN network node may apply a value of zero or a maximum allowed jitter as the value of the jitter. In some aspects, the network node may be configured with the default value and/or a parameter for selecting the default value (e.g., an indication to select the maximum allowed jitter, among other examples).

In some aspects, the application server may indicate a delay budget (e.g., a dynamic PSDB) for the PDU set (e.g., in metadata, a header, and/or an application layer, among other examples). For example, the server may provide an absolute time by which the PDU set should be delivered. The absolute time may be indicated as a reference time (e.g., ReferenceTime information element) that is set to a day, second, millisecond (ms), among other examples. The PDU set should be delivered by the reference time. In these examples, the application server may be required to be time-synchronized with the network node and/or the CN network node.

In some aspects, the application server may provide the deadline as a delay budget time by which the PDU set should be delivered. For example, the application server may indicate an amount of time (e.g., 10 ms) as the PSDB. In these examples, the application server is not required to be time-synchronized with the network node and/or the CN network node.

In some aspects, an application layer header (e.g., RTP header and/or GTP-U header) includes the jitter value. In some aspects, the application server may add the jitter in every PDU set header. To reduce the overhead of the jitter in the PDU set header, the jitter value may be quantized (e.g., digitized) to a certain level of granularity. Additionally, or alternatively, to reduce the overhead of the jitter in the PDU set header, the jitter value may be referenced from a table or other data storage structure having ranges of jitter values. The application server and a CN network node may negotiate a bit mapping method of the jitter when a connection is being established, or after the session is established.

In some aspects, the application server may dynamically update the PSDB of a PDU set based at least in part on an update to a jitter of packet generation time, a de-jitter buffer status of an application client of an associated UE (e.g., a change in an amount of data in a buffer and/or a change of PSDB margin), and/or a shift of packet generation time according to a phase locked loop at the application layer, among other examples.

In some aspects, a UPF (e.g., CN UPF) may relay the jitter of a PDU set to a network node (e.g., a RAN network node). The UPF may read the jitter of the PDU set from an RTP header, and convert the indication of the jitter to a network protocol indication, such as a GTP-U header. The UPF may indicate the jitter of the PDU set to the network node CU over an N3 interface. The network node CU may relay the jitter of the PDU set to a network node DU over an F1 interface.

In some aspects, a GTP-U header for N3 and F1 interface may be enhanced to include the jitter information. For example, the GTP-U header may include a new information element of jitter of a PDU set (e.g., for an N3/F1 interface, among other examples). The UPF may provide the jitter of the PDU set (e.g., a current PDU set) to the network node. To reduce the information bits of GTP-U header, the jitter can be quantized (e.g., digitized) by a certain step (e.g., most significant bits of the jitter amount) or may be mapped by a table.

Based at least in part on the network node receiving an indication of a deadline for transmission of a PDU set from an associated application server (with the indication of the deadline including an indication of a jitter of a PDU set, an indication of a packet delay budget that is based at least in part on the jitter of the PDU set and a nominal PSDB, and/or an indication of an absolute time of the deadline), the network node may transmit the PDU sets in accordance with the deadline. In some examples, the indication of the deadline including an indication of a jitter of a PDU set, an indication of a packet delay budget that is based at least in part on the jitter of the PDU set and a nominal PSDB, and/or an indication of an absolute time of the deadline may permit the network node to transmit the PDU sets in accordance with the deadline without requiring synchronization among a server and a client, and/or without requiring information of a traffic pattern (e.g., an XR traffic pattern, periodicity, nominal arrival time, among other examples). Additionally, or alternatively, this may allow the network node to support additional devices in a cell operated by the network node, which may improve efficiency of the cell and conserve computing, power, communication, and/or network resources that may have otherwise been used to form and/or operate an additional cell to support the additional devices. For example, based at least in part on using the indication of the deadline, the network node may schedule transmission of the PDU sets without unnecessarily prioritizing the data packets ahead of other data packets that have greater urgency. By avoiding unnecessarily prioritizing the data packets, the network node may support additional devices based at least in part on scheduling flexibility (e.g., instead of using a rigid delay budget) that may provide the network node with a larger timing window for transmitting the PDU sets and transmitting communications for the additional devices.

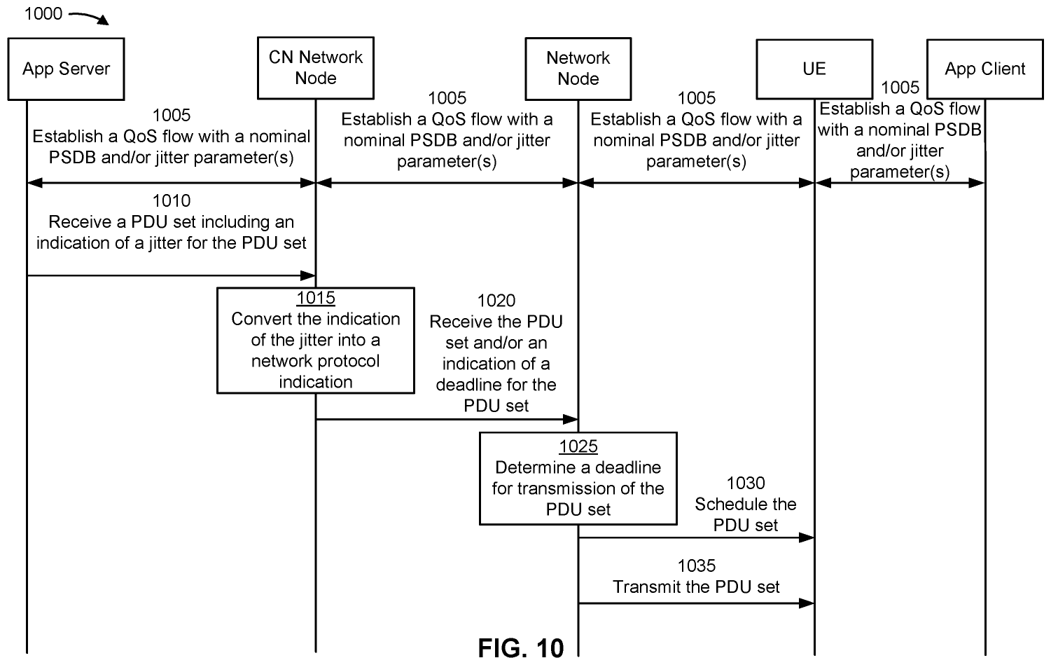

FIG. 10 is a diagram of an example 1000 associated with deadline-based data packets, in accordance with the present disclosure. As shown in FIG. 10, multiple network nodes may communicate with a UE (e.g., UE 120). The multiple network nodes may include one or more base stations 110, one or more CUs, one or more DUs, one or more RUs, one or more core network nodes, one or more network servers, one or more application servers, and/or one or more AMFs, among other examples. In some aspects, the UE and a network node (e.g., a RAN network node) of the multiple network nodes may be part of a wireless network (e.g., wireless network 100). The UE and the network node may have established a wireless connection prior to operations shown in FIG. 10.

As shown by reference number 1005, an application server, a CN network node, the network node, the UE, and an application client of the UE may establish a QoS flow with a nominal PSDB and/or one or more jitter parameters. For example, the CN network node (e.g., the 5G core network) may set a new “QoS flow nominal PSDB” in a PDU session. The QoS flow may indicate a nominal PSDB instead of a PDB.

In some aspects, the application server and/or the CN network node may define one or more of the jitter parameters. For example, the CN network node may define a maximum allowed jitter. The maximum allowed jitter may be for a particular flow or for all flows having a nominal PSDB. The CN network node may provide an indication of the maximum allowed jitter associated with the QoS flow to the network node and/or to the application server. In some aspects, the CN network node and/or the application server may define a default value of the jitter (e.g., to be used when a jitter is not indicated with the PDU), a quantization of the indication of the jitter (e.g., an allowed granularity of jitter length that can be indicated), and/or a mapping of field values (e.g., in metadata, headers, and/or other parts of the PDU set) to values of the jitter.

In some aspects, the CN, network node, and application server may perform time-synchronizing to obtain synchronized timing. In this way, the application server may provide the indication of the absolute time of the deadline, with the absolute time of the deadline based at least in part on the synchronized timing.

As shown by reference number 1010, the CN network node may receive, and the application server may provide, a PDU set including an indication of a jitter for the PDU set. In some aspects, the indication of the jitter for the PDU set may be included in metadata of the PDU set, a header of the PDU set, a GTP-U header of the PDU set, or an RTP protocol header, among other examples.

In some aspects, the application server may indicate the jitter for the PDU set and/or the nominal PSDB such that a deadline is indicated to the network node and/or the CN network node. The deadline may be based at least in part on a jitter of packet generation times of the PDU set at the application server, a de-jitter buffer status of an application client associated with the PDU set (e.g., at the UE), and/or a shift in packet generation time associated with a phase locked loop at an application layer associated with the PDU set, among other examples.

As shown by reference number 1015, the CN network node may convert the indication of the jitter into a network protocol indication. For example, the CN network node may receive the indication of the jitter in an RTP header and may convert the indication of the jitter into a GTP-U header for forwarding to the network node.

As shown by reference number 1020, the network node may receive, and the CN network node may provide, the PDU set and/or an indication of a deadline for the PDU set. In this way, the network node may receive the indication of the deadline for the PDU set from the application server via the CN network node.

In some aspects, the indication of the deadline for the PDU includes an indication of a jitter of a PDU set, an indication of a packet delay budget that is based at least in part on the jitter of the PDU set and a nominal PSDB, or an indication of an absolute time of the deadline, among other examples.

As shown by reference number 1025, the network node may determine a deadline for transmission of the PDU set. In some aspects, the network node may determine the deadline based at least in part on the indication of the jitter and the nominal PSDB. For example, the network node may determine the deadline from the nominal PSDB with an offset that is based at least in part on the jitter. In a case with a negative value of the jitter, the deadline may be offset from the nominal PSDB by increasing the nominal PSDB. In a case with a positive value of the jitter, the deadline may be offset from the nominal PSDB by decreasing the nominal PSDB.

In some aspects, the deadline for transmitting the PDU set is based at least in part on the maximum allowed jitter and the nominal PSDB. For example, the application server may provide an indication of a jitter for the PDU set, with the jitter exceeding the maximum allowed jitter. The network node may use the maximum allowed jitter instead of the jitter as indicated by the application server to determine the deadline.

In some aspects, the deadline for transmitting the PDU set is based at least in part on the default value of the jitter and the nominal PSDB. For example, the application server may omit an indication of a jitter for the PDU set and the network node may be configured with a default value for the jitter (e.g., a maximum allowed jitter or zero, among other examples).

As shown by reference number 1030, the network node may schedule the PDU set. In some aspects, the network node may schedule the PDU set such that the PDU set satisfies the deadline as indicated from the application server (e.g., using the nominal PSDB and the jitter, or using an indication of a dynamic PSDB after time-synchronization). For example, the network node may schedule the PDU set at an earliest time at which the PDU set is a highest priority and/or is closest to a deadline for transmission of packets buffered for transmission by the network node.

As shown by reference number 1035, the network node may transmit the PDU set. For example, the UE may transmit the PDU set at a time that is based at least in part on the indication of the deadline. The network node may transmit the PDU set using resources that are scheduled as described in connection with reference number 1030 and/or using periodic resources, such as semi-persistent-scheduling (SPS)-based resources, among other examples.

Based at least in part on the network node receiving an indication for transmission of a PDU set from an associated application server (with the indication of the deadline including an indication of a jitter of a PDU set, an indication of a packet delay budget that is based at least in part on the jitter of the PDU set and a nominal PSDB, and/or an indication of an absolute time of the deadline), the network node may obtain actual timing requirements of PDU sets. This may allow the network node to support additional devices in a cell operated by the network node, which may conserve computing, power, communication, and/or network resources that may have otherwise been used to form and/or operate an additional cell to support the additional devices.

As indicated above, FIG. 10 is provided as an example. Other examples may differ from what is described with regard to FIG. 10.

FIG. 11 is a diagram illustrating an example process 1100 performed, for example, by a UE, in accordance with the present disclosure. Example process 1100 is an example where the UE (e.g., UE 120) performs operations associated with deadline-based data packets.

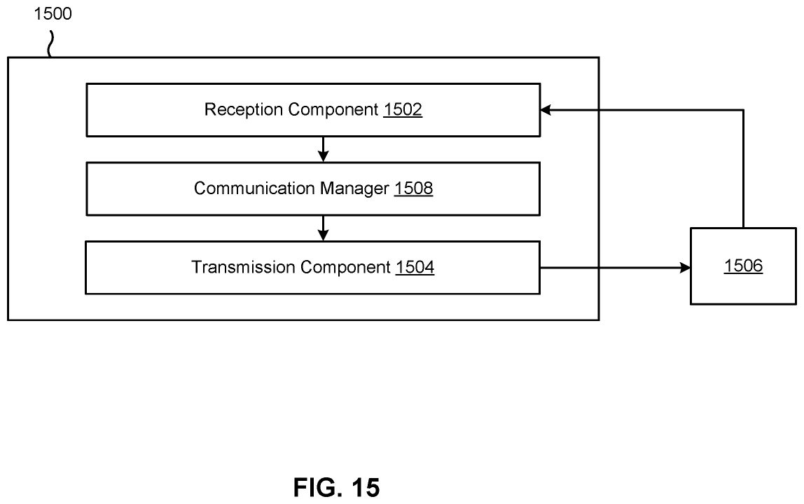

As shown in FIG. 11, in some aspects, process 1100 may include transmitting, to a network node, an indication of one or more of a deadline, a periodicity, a nominal packet delay budget, a jitter of burst arrival times, or a nominal arrival time of data packets of a communication session (block 1110). For example, the UE (e.g., using communication manager 140 and/or transmission component 1504, depicted in FIG. 15) may transmit, to a network node, an indication of one or more of a deadline, a periodicity, a nominal packet delay budget, a jitter of burst arrival times, or a nominal arrival time of data packets of a communication session, as described above. In some aspects, the UE may transmit the indication via metadata of a PDU set (e.g., within an application layer header).

As further shown in FIG. 11, in some aspects, process 1100 may include receiving one or more data packets based at least in part on the one or more data packets arriving at or before the deadline (block 1120). For example, the UE (e.g., using communication manager 140 and/or reception component 1502, depicted in FIG. 15) may receive one or more data packets based at least in part on the one or more data packets arriving at or before the deadline, as described above.

Process 1100 may include additional aspects, such as any single aspect or any combination of aspects described below and/or in connection with one or more other processes described elsewhere herein.

In a first aspect, process 1100 includes receiving, from an application client at the UE, information indicating the deadline, the periodicity, the nominal packet delay budget, the jitter of burst arrival times, or the nominal arrival time of data packets of the communication session.

In a second aspect, alone or in combination with the first aspect, process 1100 includes converting the deadline into a radio access network (RAN) time domain to create a converted deadline, the deadline indicated by the indication being the converted deadline.

In a third aspect, alone or in combination with one or more of the first and second aspects, converting the deadline into a RAN time domain comprises converting the deadline from an application time domain to the RAN time domain based at least in part on one or more of deadline mapping associated with a QoS flow, one or more deadline notification messages, or one or more DRB QoS parameters associated with the deadline.

In a fourth aspect, alone or in combination with one or more of the first through third aspects, process 1100 includes identifying a burst index of the data packets based at least in part on one or more of bursting metadata available at an application layer of the data packets, or a determined burst index based at least in part on timing of the data packets, wherein the deadline is a periodic deadline, and wherein the burst index is associated with an occasion of the deadline.

In a fifth aspect, alone or in combination with one or more of the first through fourth aspects, process 1100 includes identifying an IP flow to which the deadline applies, the IP flow being associated with the data packets (e.g., the UE receives the data packets via the IP flow) and identified based at least in part on one or more of an indication of the IP flow via an application layer of the data packets, or a determined logical channel identification based at least in part on an IP packet index of the data packets.

In a sixth aspect, alone or in combination with one or more of the first through fifth aspects, process 1100 includes translating the IP flow into a QoS flow to which the deadline applies.

In a seventh aspect, alone or in combination with one or more of the first through sixth aspects, process 1100 includes transmitting one or more of an indication that a QoS flow or logical channel associated with the data packets is associated with the deadline, an indication of a burst index associated with an occasion of the deadline, or an indication that a logical channel identification associated with the data packets is associated with the deadline.

In an eighth aspect, alone or in combination with one or more of the first through seventh aspects, process 1100 includes receiving an additional indication that the QoS flow or logical channel is configured with the deadline and transmitting an indication that the QoS flow or logical channel associated with the data packets is associated with the deadline.

In a ninth aspect, alone or in combination with one or more of the first through eighth aspects, process 1100 includes receiving an indication that expiration of the data packets of the communication session is associated with the deadline and is not associated with a packet delay budget, or transmitting an indication that expiration of the data packets of the communication session is associated with the deadline and is not associated with a packet delay budget.

In a tenth aspect, alone or in combination with one or more of the first through ninth aspects, process 1100 includes receiving an indication of acceptance of the deadline, the periodicity, the nominal packet delay budget, the jitter of burst arrival times, or the nominal arrival time of data packets of the communication session.

In an eleventh aspect, alone or in combination with one or more of the first through tenth aspects, transmitting the indication of one or more of the deadline, the periodicity, the nominal packet delay budget, the jitter of burst arrival times, or the nominal arrival time of data packets of the communication session comprises transmitting the indication via a RRC message, transmitting the indication via a MAC CE, or transmitting the indication via an application layer indication.

In a twelfth aspect, alone or in combination with one or more of the first through eleventh aspects, the deadline is associated with a periodic display time and a UE internal data processing time.

In a thirteenth aspect, alone or in combination with one or more of the first through twelfth aspects, process 1100 includes receiving an indication of a downlink resource for receiving the data packets, the downlink resource based at least in part on the indication of the deadline, the periodicity, the nominal packet delay budget, the jitter of burst arrival times, or the nominal arrival time of data packets of the communication session, wherein the data packets are received based on the downlink resource.

In a fourteenth aspect, alone or in combination with one or more of the first through thirteenth aspects, process 1100 includes receiving an indication of a mapping of QoS flows to IP flows, wherein transmitting the indication of the deadline, the periodicity, the nominal packet delay budget, the jitter of burst arrival times, or the nominal arrival time comprises transmitting, based at least in part on the mapping of the QoS flows to the IP flows, an additional indication that a QoS flow is associated with the deadline, the periodicity, the nominal packet delay budget, the jitter of burst arrival times, or the nominal arrival time.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., a base station, a CU, a DU, and/or an RU) performs operations associated with deadline-based data packets.

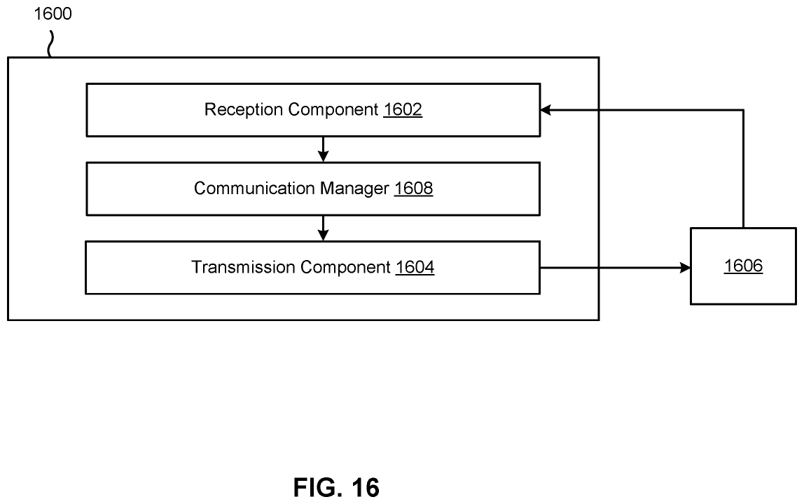

As shown in FIG. 12, in some aspects, process 1200 may include receiving an indication of one or more of a deadline, a periodicity, a nominal packet delay budget, a jitter of burst arrival times, or a nominal arrival time associated with data packets of a communication session (block 1210). For example, the network node (e.g., using communication manager 150 and/or reception component 1602, depicted in FIG. 16) may receive an indication of one or more of a deadline, a periodicity, a nominal packet delay budget, a jitter of burst arrival times, or a nominal arrival time associated with data packets of a communication session, as described above. In some aspects, the network node may receive the indication via metadata of a PDU set (e.g., within an application layer header). In some aspects, the network node may receive the PDU set from the UE or from a network node.

As further shown in FIG. 12, in some aspects, process 1200 may include transmitting one or more data packets based at least in part on the one or more data packets transmitted at or before the deadline (block 1220). For example, the network node (e.g., using communication manager 150 and/or transmission component 1604, depicted in FIG. 16) may transmit one or more data packets based at least in part on the one or more data packets transmitted at or before the deadline, as described above.

Process 1200 may include additional aspects, such as any single aspect or any combination of aspects described below and/or in connection with one or more other processes described elsewhere herein.

In a first aspect, receiving the indication comprising one or more of receiving, from a UE associated with the data packets, information indicating one or more of the deadline, the periodicity, the nominal packet delay budget, the jitter of burst arrival times, or the nominal arrival time of data packets of the communication session, or receiving, from an application server associated with the data packets, information indicating the deadline, the periodicity, the nominal packet delay budget, the jitter of burst arrival times, or the nominal arrival time of data packets of the communication session.

In a second aspect, alone or in combination with the first aspect, receiving the indication of one or more of the deadline, a periodicity, a nominal packet delay budget, the jitter of burst arrival times, or the nominal arrival time of data packets of the communication session comprises receiving the indication via a RRC message, receiving the indication via a MAC CE, or receiving the indication via an application layer indication.

In a third aspect, alone or in combination with one or more of the first and second aspects, the deadline is associated with a periodic display time and a UE internal data processing time.

In a fourth aspect, alone or in combination with one or more of the first through third aspects, process 1200 includes transmitting an indication of a downlink resource for receiving the data packets, the downlink resource based at least in part on the indication of the deadline, a periodicity, a nominal packet delay budget, the jitter of burst arrival times, or the nominal arrival time of data packets of the communication session, wherein the data packets are received by a receiving device based at least in part on the downlink resources.

In a fifth aspect, alone or in combination with one or more of the first through fourth aspects, process 1200 includes grouping data packets into a burst group based at least in part on the indication of the deadline, a periodicity, a nominal packet delay budget, the jitter of burst arrival times, or the nominal arrival time of data packets of the communication session.

In a sixth aspect, alone or in combination with one or more of the first through fifth aspects, process 1200 includes receiving one or more of an indication that a QoS flow or logical channel associated with the data packets is associated with the deadline, an indication of a burst index associated an occasion of the deadline, or an indication that a logical channel identification associated with the data packets is associated with the deadline.

In a seventh aspect, alone or in combination with one or more of the first through sixth aspects, process 1200 includes transmitting an additional indication that the QoS flow or logical channel is configured with the deadline based at least in part on receiving the indication that the QoS flow or logical channel associated with the data packets is associated with the deadline.

In an eighth aspect, alone or in combination with one or more of the first through seventh aspects, process 1200 includes transmitting an indication of a mapping of QoS flows to IP flows for translating an IP flow to which the deadline applies into a QoS flow to which the deadline applies.

In a ninth aspect, alone or in combination with one or more of the first through eighth aspects, process 1200 includes transmitting an indication of acceptance of the deadline, the periodicity, the nominal packet delay budget, the jitter of burst arrival times, or the nominal arrival time of data packets of the communication session.

In a tenth aspect, alone or in combination with one or more of the first through ninth aspects, receiving the indication of the deadline comprises receiving the indication of the deadline via a centralized unit, and the network node comprises a distributed unit.

In an eleventh aspect, alone or in combination with one or more of the first through tenth aspects, transmitting the one or more data packets comprises identifying a QoS flow associated with the data packets, applying the deadline to the data packets based at least in part on the QoS flow being associated with the deadline, and applying a periodic occasion of the deadline to the data packets based at least in part on a time at which the network node receives the data packets or an indication of a burst number of the data packets.

In a twelfth aspect, alone or in combination with one or more of the first through eleventh aspects, receiving the jitter of burst arrival times comprises receiving an indication of the jitter of burst arrival times in a user plane header.

In a thirteenth aspect, alone or in combination with one or more of the first through twelfth aspects, the jitter of burst arrival times is based at least in part on an actual burst arrival times and a nominal arrival time.

In a fourteenth aspect, alone or in combination with one or more of the first through thirteenth aspects, process 1200 includes receiving an indication that expiration of the data packets of the communication session is associated with the deadline and is not associated with a packet delay budget, or transmitting an indication that expiration of the data packets of the communication session is associated with the deadline and is not associated with a packet delay budget.

In a fifteenth aspect, alone or in combination with one or more of the first through fourteenth aspects, process 1200 includes dropping one or more additional data packets based at least in part on the one or more additional data packets failing to satisfy the deadline.

In a sixteenth aspect, alone or in combination with one or more of the first through fifteenth aspects, process 1200 includes identifying the deadline based at least in part on one or more of the periodicity, the nominal packet delay budget, the jitter of burst arrival times, or the nominal arrival time of data packets.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., base station 110, a CU, a DU, and/or an RU) performs operations associated with deadline-based data packets.

As shown in FIG. 13, in some aspects, process 1300 may include receiving an indication of a deadline for transmission of a PDU set, the indication of the deadline including one or more of: an indication of a jitter of a PDU set, an indication of a packet delay budget that is based at least in part on the jitter of the PDU set and a nominal PSDB, or an indication of an absolute time of the deadline (block 1310). For example, the network node (e.g., using communication manager 150 and/or reception component 1502, depicted in FIG. 15) may receive an indication of a deadline for transmission of a PDU set, the indication of the deadline including one or more of: an indication of a jitter of a PDU set, an indication of a packet delay budget that is based at least in part on the jitter of the PDU set and a nominal PSDB, or an indication of an absolute time of the deadline, as described above.

As further shown in FIG. 13, in some aspects, process 1300 may include transmitting the PDU set at a time that is based at least in part on the indication of the deadline (block 1320). For example, the network node (e.g., using communication manager 150 and/or transmission component 1504, depicted in FIG. 15) may transmit the PDU set at a time that is based at least in part on the indication of the deadline, as described above.

Process 1300 may include additional aspects, such as any single aspect or any combination of aspects described below and/or in connection with one or more other processes described elsewhere herein.

In a first aspect, receiving the indication of the deadline comprises receiving the indication of the deadline from an application server associated with the PDU set.

In a second aspect, alone or in combination with the first aspect, receiving the indication of the deadline comprises receiving the indication of the deadline via one or more of metadata of the PDU set, a header of the PDU set, a GTP-U header of the PDU set, or an RTP protocol header.

In a third aspect, alone or in combination with one or more of the first and second aspects, process 1300 includes determining the deadline based at least in part on the indication of the jitter and the nominal PSDB, wherein the PDU set is transmitted based at least in part on the deadline.

In a fourth aspect, alone or in combination with one or more of the first through third aspects, process 1300 includes receiving an indication of the nominal PSDB associated with a flow that includes the PDU set.

In a fifth aspect, alone or in combination with one or more of the first through fourth aspects, determining the deadline based at least in part on the indication of the jitter and the nominal PSDB comprises determining the deadline from the nominal PSDB with an offset that is based at least in part on the jitter.

In a sixth aspect, alone or in combination with one or more of the first through fifth aspects, process 1300 includes receiving an indication of a maximum allowed jitter associated with a flow that includes the PDU set.

In a seventh aspect, alone or in combination with one or more of the first through sixth aspects, the jitter exceeds the maximum allowed jitter, and the time for transmitting the PDU set is based at least in part on the maximum allowed jitter.

In an eighth aspect, alone or in combination with one or more of the first through seventh aspects, the indication of the jitter comprises a default value of the jitter that is implicitly indicated based at least in part on the PDU set omitting an explicit indication of the jitter, a quantized value of the jitter, or a field value that maps to a value of the jitter.

In a ninth aspect, alone or in combination with one or more of the first through eighth aspects, the indication of the jitter comprises a default value of the jitter that is implicitly indicated based at least in part on the PDU set omitting an explicit indication of the jitter, and the default value is zero or a maximum allowed jitter.

In a tenth aspect, alone or in combination with one or more of the first through ninth aspects, process 1300 includes time-synchronizing, with an application server associated with the PDU set, to obtain synchronized timing between the application server and the network node, wherein the indication of the deadline includes the indication of the absolute time of the deadline, and wherein the absolute time of the deadline is based at least in part on the synchronized timing.

In an eleventh aspect, alone or in combination with one or more of the first through tenth aspects, the deadline is based at least in part on one or more of a jitter of packet generation times of the PDU set, a dejitter buffer status of an application client associated with the PDU set, or a shift in packet generation time associated with a phase locked loop at an application layer associated with the PDU set.

In a twelfth aspect, alone or in combination with one or more of the first through eleventh aspects, process 1300 includes scheduling the transmission of the PDU set based at least in part on the indication of the deadline, wherein transmitting the PDU set is based at least in part on scheduling the transmission.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by an application server, in accordance with the present disclosure. Example process 1400 is an example where the application server (e.g., device 1700) performs operations associated with deadline-based data packets.

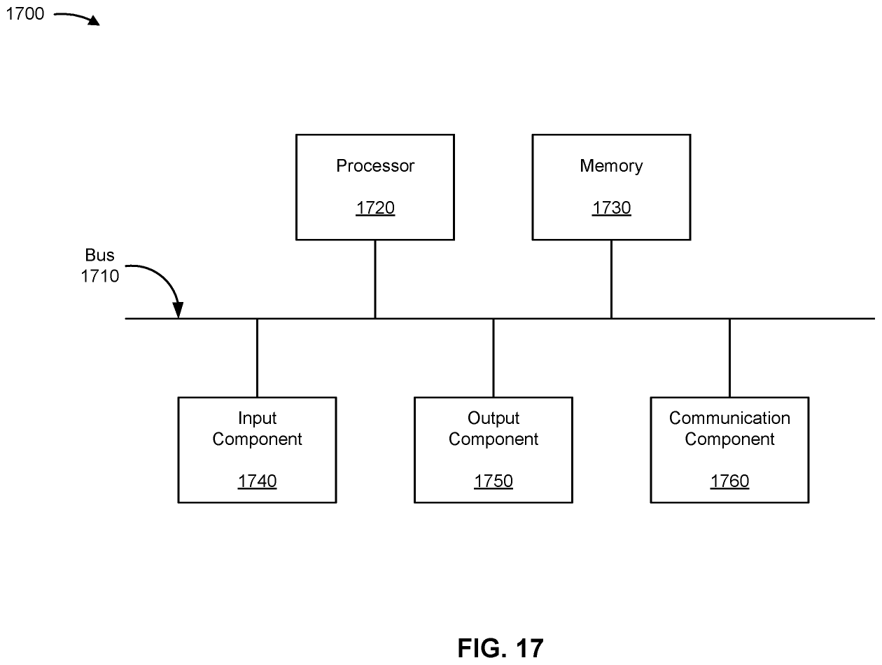

As shown in FIG. 14, in some aspects, process 1400 may include providing an indication of a deadline for transmission of a PDU set, the indication of the deadline including one or more of: an indication of a jitter of the PDU set, an indication of a packet delay budget that is based at least in part on the jitter of the PDU set and a nominal PSDB, or an indication of an absolute time of the deadline (block 1410). For example, the application server (e.g., using communication component 1760, depicted in FIG. 17) may provide an indication of a deadline for transmission of a PDU set, the indication of the deadline including one or more of: an indication of a jitter of the PDU set, an indication of a packet delay budget that is based at least in part on the jitter of the PDU set and a nominal PSDB, or an indication of an absolute time of the deadline, as described above.

As further shown in FIG. 14, in some aspects, process 1400 may include receiving the PDU set at a time that is based at least in part on the indication of the deadline (block 1420). For example, the application server (e.g., using communication component 1760, depicted in FIG. 17) may receive the PDU set at a time that is based at least in part on the indication of the deadline, as described above.

Process 1400 may include additional aspects, such as any single aspect or any combination of aspects described below and/or in connection with one or more other processes described elsewhere herein.

In a first aspect, providing the indication of the deadline comprises providing the indication of the deadline via one or more of metadata of the PDU set, a header of the PDU set, or an RTP protocol header.

In a second aspect, alone or in combination with the first aspect, process 1400 includes providing an indication of the nominal PSDB associated with a flow that includes the PDU set.

In a third aspect, alone or in combination with one or more of the first and second aspects, the deadline is based at least in part on the nominal PSDB with an offset that is based at least in part on the jitter.

In a fourth aspect, alone or in combination with one or more of the first through third aspects, process 1400 includes receiving an indication of a maximum allowed jitter associated with a flow that includes the PDU set.

In a fifth aspect, alone or in combination with one or more of the first through fourth aspects, the indication of the jitter comprises a default value of the jitter that is implicitly indicated based at least in part on the PDU set omitting an explicit indication of the jitter, a quantized value of the jitter, or a field value that maps to a value of the jitter.

In a sixth aspect, alone or in combination with one or more of the first through fifth aspects, the indication of the jitter comprises a default value of the jitter that is implicitly indicated based at least in part on the PDU set omitting an explicit indication of the jitter, and the default value is zero or a maximum allowed jitter.

In a seventh aspect, alone or in combination with one or more of the first through sixth aspects, process 1400 includes time-synchronizing, with an application server associated with the PDU set, to obtain synchronized timing between the application server and the network node, wherein the indication of the deadline includes the indication of the absolute time of the deadline, and wherein the absolute time of the deadline is based at least in part on the synchronized timing.

In an eighth aspect, alone or in combination with one or more of the first through seventh aspects, the deadline is based at least in part on one or more of a jitter of packet generation times of the PDU set, a dejitter buffer status of an application client associated with the PDU set, or a shift in packet generation time associated with a phase locked loop at an application layer associated with the PDU set.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include a communication manager 1508 (e.g., the communication manager 140).

In some aspects, the apparatus 1500 may be configured to perform one or more operations described herein in connection with FIGS. 6-10. Additionally, or alternatively, the apparatus 1500 may be configured to perform one or more processes described herein, such as process 1100 of FIG. 11. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The transmission component 1504 may transmit, to a network node, an indication of one or more of a deadline, a periodicity, a nominal packet delay budget, a jitter of burst arrival times, or a nominal arrival time of data packets of a communication session. The reception component 1502 may receive one or more data packets based at least in part on the one or more data packets arriving at or before the deadline.

The reception component 1502 may receive, from an application client at the UE, information indicating the deadline, the periodicity, the nominal packet delay budget, the jitter of burst arrival times, or the nominal arrival time of data packets of the communication session.

The communication manager 1508 may convert the deadline into a RAN time domain to create a converted deadline the deadline indicated by the indication being the converted deadline.

The communication manager 1508 may identify a burst index of the data packets based at least in part on one or more of burst metadata available at an application layer of the data packets, or a determined burst index based at least in part on timing of the data packets, wherein the deadline is a periodic deadline, and wherein the burst index is associated with an occasion of the deadline.

The communication manager 1508 may identify an IP flow to which the deadline applies, the IP flow being associated with the data packets and identified based at least in part on one or more of an indication of the IP flow via an application layer of the data packets, or a determined logical channel identification based at least in part on an IP packet index of the data packets.

The communication manager 1508 may translate the IP flow into a QoS flow to which the deadline applies.

The transmission component 1504 may transmit one or more of an indication that a QoS flow or logical channel associated with the data packets is associated with the deadline, an indication of a burst index associated with an occasion of the deadline, or an indication that a logical channel identification associated with the data packets is associated with the deadline.

The reception component 1502 may receive an additional indication that the QoS flow or logical channel is configured with the deadline and transmitting an indication that the QoS flow or logical channel associated with the data packets is associated with the deadline.

The reception component 1502 may receive an indication that expiration of the data packets of the communication session is associated with the deadline and is not associated with a packet delay budget.

The transmission component 1504 may transmit an indication that expiration of the data packets of the communication session is associated with the deadline and is not associated with a packet delay budget.

The reception component 1502 may receive an indication of acceptance of the deadline, the periodicity, the nominal packet delay budget, the jitter of burst arrival times, or the nominal arrival time of data packets of the communication session.

The reception component 1502 may receive an indication of a downlink resource for receiving the data packets, the downlink resource based at least in part on the indication of the deadline, the periodicity, the nominal packet delay budget, the jitter of burst arrival times, or the nominal arrival time of data packets of the communication session wherein the data packets are received based on the downlink resource.

The reception component 1502 may receive an indication of a mapping of QoS flows to IP flows.

FIG. 16 is a diagram of an example apparatus 1600 for wireless communication. The apparatus 1600 may be a network node, or a network node may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include a communication manager (e.g., the communication manager 150).

In some aspects, the apparatus 1600 may be configured to perform one or more operations described herein in connection with FIGS. 6-10. Additionally, or alternatively, the apparatus 1600 may be configured to perform one or more processes described herein, such as process 1200 of FIG. 12, process 1300 of FIG. 13, and/or a combination thereof. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

The reception component 1602 may receive an indication of one or more of a deadline, a periodicity, a nominal packet delay budget, a jitter of burst arrival times, or a nominal arrival time associated with data packets of a communication session. The transmission component 1604 may transmit one or more data packets based at least in part on the one or more data packets transmitted at or before the deadline.

The transmission component 1604 may transmit an indication of a downlink resource for receiving the data packets, the downlink resource based at least in part on the indication of the deadline, a periodicity, a nominal packet delay budget, the jitter of burst arrival times, or the nominal arrival time of data packets of the communication session, wherein the data packets are received by a receiving device based at least in part on the downlink resources.

The communication manager 1608 may group data packets into a burst group based at least in part on the indication of the deadline, a periodicity, a nominal packet delay budget, the jitter of burst arrival times, or the nominal arrival time of data packets of the communication session.

The reception component 1602 may receive one or more of an indication that a QoS flow or logical channel associated with the data packets is associated with the deadline, an indication of a burst index associated an occasion of the deadline, or an indication that a logical channel identification associated with the data packets is associated with the deadline.

The transmission component 1604 may transmit an additional indication that the QoS flow or logical channel is configured with the deadline based at least in part on receiving the indication that the QoS flow or logical channel associated with the data packets is associated with the deadline.

The transmission component 1604 may transmit an indication of a mapping of QoS flows to IP flows for translating an IP flow to which the deadline applies into a QoS flow to which the deadline applies.

The transmission component 1604 may transmit an indication of acceptance of the deadline, the periodicity, the nominal packet delay budget, the jitter of burst arrival times, or the nominal arrival time of data packets of the communication session.

The reception component 1602 may receive an indication that expiration of the data packets of the communication session is associated with the deadline and is not associated with a packet delay budget.

The transmission component 1604 may transmit an indication that expiration of the data packets of the communication session is associated with the deadline and is not associated with a packet delay budget.

The communication manager 1608 may drop one or more additional data packets based at least in part on the one or more additional data packets failing to satisfy the deadline.

The communication manager 1608 may identify the deadline based at least in part on one or more of the periodicity, the nominal packet delay budget, the jitter of burst arrival times, or the nominal arrival time of data packets.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The reception component 1602 may receive an indication of a deadline for transmission of a PDU set, the indication of the deadline including one or more of an indication of a jitter of the PDU set, an indication of a packet delay budget that is based at least in part on the jitter of the PDU set and a nominal PDU set delay budget (PSDB), or an indication of an absolute time of the deadline. The transmission component 1604 may transmit the PDU set at a time that is based at least in part on the indication of the deadline.

The communication manager 1608 may determine the deadline based at least in part on the indication of the jitter and the nominal PSDB wherein the PDU set is transmitted based at least in part on the deadline.

The reception component 1602 may receive an indication of the nominal PSDB associated with a flow that includes the PDU set.

The reception component 1602 may receive an indication of a maximum allowed jitter associated with a flow that includes the PDU set.

The communication manager 1608 may schedule the transmission of the PDU set based at least in part on the indication of the deadline wherein transmitting the PDU set is based at least in part on scheduling the transmission.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of example components of a device 1700, which may correspond to an application server and/or a CN network node. In some implementations, the application server and/or the CN network node include one or more devices 1700 and/or one or more components of device 1700. As shown in FIG. 17, device 1700 may include a bus 1710, a processor 1720, a memory 1730, an input component 1740, an output component 1750, and a communication component 1760.

Bus 1710 includes one or more components that enable wired and/or wireless communication among the components of device 1700. Bus 1710 may couple together two or more components of FIG. 17, such as via operative coupling, communicative coupling, electronic coupling, and/or electric coupling. Processor 1720 includes a central processing unit, a graphics processing unit, a microprocessor, a controller, a microcontroller, a digital signal processor, a field-programmable gate array, an application-specific integrated circuit, and/or another type of processing component. Processor 1720 is implemented in hardware, firmware, or a combination of hardware and software. In some implementations, processor 1720 includes one or more processors capable of being programmed to perform one or more operations or processes described elsewhere herein.

Memory 1730 includes volatile and/or nonvolatile memory. For example, memory 1730 may include random access memory (RAM), read only memory (ROM), a hard disk drive, and/or another type of memory (e.g., a flash memory, a magnetic memory, and/or an optical memory). Memory 1730 may include internal memory (e.g., RAM, ROM, or a hard disk drive) and/or removable memory (e.g., removable via a universal serial bus connection). Memory 1730 may be a non-transitory computer-readable medium. Memory 1730 stores information, instructions, and/or software (e.g., one or more software applications) related to the operation of device 1700. In some implementations, memory 1730 includes one or more memories that are coupled to one or more processors (e.g., processor 1720), such as via bus 1710.

Input component 1740 enables device 1700 to receive input, such as user input and/or sensed input. For example, input component 1740 may include a touch screen, a keyboard, a keypad, a mouse, a button, a microphone, a switch, a sensor, a global positioning system sensor, an accelerometer, a gyroscope, and/or an actuator. Output component 1750 enables device 1700 to provide output, such as via a display, a speaker, and/or a light-emitting diode. Communication component 1760 enables device 1700 to communicate with other devices via a wired connection and/or a wireless connection. For example, communication component 1760 may include a receiver, a transmitter, a transceiver, a modem, a network interface card, and/or an antenna.

Device 1700 may perform one or more operations or processes described herein. For example, a non-transitory computer-readable medium (e.g., memory 1730) may store a set of instructions (e.g., one or more instructions or code) for execution by processor 1720. Processor 1720 may execute the set of instructions to perform one or more operations or processes described herein. In some implementations, execution of the set of instructions, by one or more processors 1720, causes the one or more processors 1720 and/or the device 1700 to perform one or more operations or processes described herein. In some implementations, hardwired circuitry is used instead of or in combination with the instructions to perform one or more operations or processes described herein. Additionally, or alternatively, processor 1720 may be configured to perform one or more operations or processes described herein. Thus, implementations described herein are not limited to any specific combination of hardware circuitry and software.

In some aspects, the communication component 1760 may provide an indication of a deadline for transmission of a PDU set, the indication of the deadline including one or more of an indication of a jitter of the PDU set, an indication of a packet delay budget that is based at least in part on the jitter of the PDU set and a nominal PSDB, or an indication of an absolute time of the deadline. The reception component 1602 may receive the PDU set at a time that is based at least in part on the indication of the deadline.

In some aspects, the communication component 1760 may provide an indication of the nominal PSDB associated with a flow that includes the PDU set.

In some aspects, the communication component 1760 may receive an indication of a maximum allowed jitter associated with a flow that includes the PDU set.

The number and arrangement of components shown in FIG. 17 are provided as an example. Device 1700 may include additional components, fewer components, different components, or differently arranged components than those shown in FIG. 17. Additionally, or alternatively, a set of components (e.g., one or more components) of device 1700 may perform one or more functions described as being performed by another set of components of device 1700.

The following provides an overview of some Aspects of the present disclosure:
Aspect 1: A method of wireless communication performed by a user equipment (UE), comprising: transmitting, to a network node, an indication of one or more of a deadline, a periodicity, a nominal packet delay budget, a jitter of burst arrival times, or a nominal arrival time of data packets of a communication session; and receiving one or more data packets based at least in part on the one or more data packets arriving at or before the deadline.
Aspect 2: The method of Aspect 1, further comprising: receiving, from an application client at the UE, information indicating the deadline, the periodicity, the nominal packet delay budget, the jitter of burst arrival times, or the nominal arrival time of data packets of the communication session.
Aspect 3: The method of Aspect 2, further comprising: converting the deadline into a radio access network (RAN) time domain to create a converted deadline, the deadline indicated by the indication being the converted deadline.
Aspect 4: The method of Aspect 3, wherein converting the deadline into a RAN time domain comprises converting the deadline from an application time domain to the RAN time domain based at least in part on one or more of: deadline mapping associated with a quality of service (QoS) flow, one or more deadline notification messages, or one or more data radio bearer (DRB) QoS parameters associated with the deadline.
Aspect 5: The method of any of Aspects 3 or 4, further comprising: identifying a burst index of the data packets based at least in part on one or more of: burst metadata available at an application layer of the data packets, or a determined burst index based at least in part on timing of the data packets, wherein the deadline is a periodic deadline, and wherein the burst index is associated with an occasion of the deadline.
Aspect 6: The method of any of Aspects 1-5, further comprising: identifying an internet protocol (IP) flow to which the deadline applies, the IP flow being associated with the data packets and identified based at least in part on one or more of: an indication of the IP flow via an application layer of the data packets, or a determined logical channel identification based at least in part on an IP packet index of the data packets.
Aspect 7: The method of Aspect 6, further comprising: translating the IP flow into a quality of service (QoS) flow to which the deadline applies.
Aspect 8: The method of any of Aspects 1-7, further comprising transmitting one or more of: an indication that a quality of service (QoS) flow associated with the data packets is associated with the deadline, an indication of a burst index associated with an occasion of the deadline, or an indication that a logical channel identification associated with the data packets is associated with the deadline.
Aspect 9: The method of any of Aspects 1-8, further comprising: receiving an additional indication that the QoS flow or logical channel is configured with the deadline and transmitting an indication that the QoS flow or logical channel associated with the data packets is associated with the deadline.
Aspect 10: The method of any of Aspects 1-9, further comprising: receiving an indication that expiration of the data packets of the communication session is associated with the deadline and is not associated with a packet delay budget, or transmitting an indication that expiration of the data packets of the communication session is associated with the deadline and is not associated with a packet delay budget.
Aspect 11: The method of any of Aspects 1-10, further comprising: receiving an indication of acceptance of the deadline, the periodicity, the nominal packet delay budget, the jitter of burst arrival times, or the nominal arrival time of data packets of the communication session.
Aspect 12: The method of any of Aspects 1-11, wherein transmitting the indication of one or more of the deadline, the periodicity, the nominal packet delay budget, the jitter of burst arrival times, or the nominal arrival time of data packets of the communication session comprises: transmitting the indication via a radio resource control (RRC) message, transmitting the indication via a medium access control (MAC) control element (CE), or transmitting the indication via an application layer indication.
Aspect 13: The method of any of Aspects 1-12, wherein the deadline is associated with a periodic display time and a UE internal data processing time.
Aspect 14: The method of any of Aspects 1-13, further comprising: receiving an indication of a downlink resource for receiving the data packets, the downlink resource based at least in part on the indication of the deadline, the periodicity, the nominal packet delay budget, the jitter of burst arrival times, or the nominal arrival time of data packets of the communication session, wherein the data packets are received based on the downlink resource.
Aspect 15: The method of any of Aspects 1-14, further comprising: receiving an indication of a mapping of quality of service (QoS) flows to internet protocol (IP) flows, wherein transmitting the indication of the deadline, the periodicity, the nominal packet delay budget, the jitter of burst arrival times, or the nominal arrival time comprises: transmitting, based at least in part on the mapping of the QoS flows to the IP flows, an additional indication that a QoS flow is associated with the deadline, the periodicity, the nominal packet delay budget, the jitter of burst arrival times, or the nominal arrival time. wherein transmitting the indication of the deadline, the periodicity, the nominal packet delay budget, the jitter of burst arrival times, or the nominal arrival time comprises: transmitting, based at least in part on the mapping of the QoS flows to the IP flows, an additional indication that a QoS flow is associated with the deadline, the periodicity, the nominal packet delay budget, the jitter of burst arrival times, or the nominal arrival time.
Aspect 16: A method of wireless communication performed by a network node, comprising: receiving an indication of one or more of a deadline, a periodicity, a nominal packet delay budget, a jitter of burst arrival times, or a nominal arrival time associated with data packets of a communication session; and transmitting one or more data packets based at least in part on the one or more data packets transmitted at or before the deadline.
Aspect 17: The method of Aspect 16, wherein receiving the indication comprising one or more of: receiving, from a user equipment (UE) associated with the data packets, information indicating one or more of the deadline, the periodicity, the nominal packet delay budget, the jitter of burst arrival times, or the nominal arrival time of data packets of the communication session, or receiving, from an application server associated with the data packets, information indicating the deadline, the periodicity, the nominal packet delay budget, the jitter of burst arrival times, or the nominal arrival time of data packets of the communication session.
Aspect 18: The method of Aspect 17, wherein receiving the indication of one or more of the deadline, a periodicity, a nominal packet delay budget, the jitter of burst arrival times, or the nominal arrival time of data packets of the communication session comprises: receiving the indication via a radio resource control (RRC) message, receiving the indication via a medium access control (MAC) control element (CE), or receiving the indication via an application layer indication.
Aspect 19: The method of any of Aspects 16-18, wherein the deadline is associated with a periodic display time and a UE internal data processing time.
Aspect 20: The method of any of Aspects 16-19, further comprising: transmitting an indication of a downlink resource for receiving the data packets, the downlink resource based at least in part on the indication of the deadline, a periodicity, a nominal packet delay budget, the jitter of burst arrival times, or the nominal arrival time of data packets of the communication session, wherein the data packets are received by a receiving device based at least in part on the downlink resources.
Aspect 21: The method of any of Aspects 16-20, further comprising: grouping data packets into a burst group based at least in part on the indication of the deadline, a periodicity, a nominal packet delay budget, the jitter of burst arrival times, or the nominal arrival time of data packets of the communication session.
Aspect 22: The method of any of Aspects 16-21, further comprising receiving one or more of: an indication that a quality of service (QoS) flow associated with the data packets is associated with the deadline, an indication of a burst index associated an occasion of the deadline, or an indication that a logical channel identification associated with the data packets is associated with the deadline.
Aspect 23: The method of any of Aspects 16-22, further comprising: transmitting an additional indication that the QoS flow or logical channel is configured with the deadline based at least in part on receiving an indication that the QoS flow or logical channel associated with the data packets is associated with the deadline.
Aspect 24: The method of any of Aspects 16-23, further comprising: transmitting an indication of a mapping of quality of service (QoS) flows to internet protocol (IP) flows for translating an IP flow to which the deadline applies into a QoS flow to which the deadline applies.
Aspect 25: The method of any of Aspects 16-24, further comprising: transmitting an indication of acceptance of the deadline, the periodicity, the nominal packet delay budget, the jitter of burst arrival times, or the nominal arrival time of data packets of the communication session.
Aspect 26: The method of any of Aspects 16-25, wherein receiving the indication of the deadline comprises receiving the indication of the deadline via a centralized unit, and wherein the network node comprises a distributed unit.
Aspect 27: The method of any of Aspects 16-26, wherein transmitting the one or more data packets comprises: identifying a quality of service (QoS) flow associated with the data packets; applying the deadline to the data packets based at least in part on the QoS flow being associated with the deadline; and applying a periodic occasion of the deadline to the data packets based at least in part on a time at which the network node receives the data packets or an indication of a burst number of the data packets.
Aspect 28: The method of any of Aspects 16-27, wherein receiving the jitter of burst arrival times comprises: receiving an indication of the jitter of burst arrival times in a user plane header.
Aspect 29: The method of any of Aspects 16-28, wherein the jitter of burst arrival times is based at least in part on an actual burst arrival times and a nominal arrival time.
Aspect 30: The method of any of Aspects 16-29, further comprising: receiving an indication that expiration of the data packets of the communication session is associated with the deadline and is not associated with a packet delay budget, or transmitting an indication that expiration of the data packets of the communication session is associated with the deadline and is not associated with a packet delay budget.
Aspect 31: The method of any of Aspects 16-30, further comprising: dropping one or more additional data packets based at least in part on the one or more additional data packets failing to satisfy the deadline.
Aspect 32: The method of any of Aspects 16-31, further comprising: identifying the deadline based at least in part on one or more of the periodicity, the nominal packet delay budget, the jitter of burst arrival times, or the nominal arrival time of data packets.
Aspect 33: An apparatus for wireless communication at a device, comprising a processor; memory coupled with the processor; and instructions stored in the memory and executable by the processor to cause the apparatus to perform the method of one or more of Aspects 1-32.
Aspect 34: A device for wireless communication, comprising a memory and one or more processors coupled to the memory, the one or more processors configured to perform the method of one or more of Aspects 1-32.
Aspect 35: An apparatus for wireless communication, comprising at least one means for performing the method of one or more of Aspects 1-32.
Aspect 36: A non-transitory computer-readable medium storing code for wireless communication, the code comprising instructions executable by a processor to perform the method of one or more of Aspects 1-32.
Aspect 37: A non-transitory computer-readable medium storing a set of instructions for wireless communication, the set of instructions comprising one or more instructions that, when executed by one or more processors of a device, cause the device to perform the method of one or more of Aspects 1-32.

The following provides an overview of some additional Aspects of the present disclosure:
Aspect 1: A method of wireless communication performed by a network node, comprising: receiving an indication of a deadline for transmission of a protocol data unit (PDU) set, the indication of the deadline including one or more of: an indication of a jitter of the PDU set, an indication of a packet delay budget that is based at least in part on the jitter of the PDU set and a nominal PDU set delay budget (PSDB), or an indication of an absolute time of the deadline; and transmitting the PDU set at a time that is based at least in part on the indication of the deadline.
Aspect 2: The method of Aspect 1, wherein receiving the indication of the deadline comprises: receiving the indication of the deadline from an application server associated with the PDU set.
Aspect 3: The method of any of Aspects 1-2, wherein receiving the indication of the deadline comprises receiving the indication of the deadline via one or more of: metadata of the PDU set, a header of the PDU set, a general packet radio service (GPRS) tunnelling protocol user plane (GTP-U) header of the PDU set, or a real-time transport (RTP) protocol header.
Aspect 4: The method of any of Aspects 1-3, further comprising: determining the deadline based at least in part on the indication of the jitter and the nominal PSDB, wherein the PDU set is transmitted based at least in part on the deadline.
Aspect 5: The method of Aspect 4, further comprising: receiving an indication of the nominal PSDB associated with a flow that includes the PDU set.
Aspect 6: The method of any of Aspects 4-5, wherein determining the deadline based at least in part on the indication of the jitter and the nominal PSDB comprises: determining the deadline from the nominal PSDB with an offset that is based at least in part on the jitter.
Aspect 7: The method of any of Aspects 1-6, further comprising: receiving an indication of a maximum allowed jitter associated with a flow that includes the PDU set.
Aspect 8: The method of Aspect 7, wherein the jitter exceeds the maximum allowed jitter, and wherein the time for transmitting the PDU set is based at least in part on the maximum allowed jitter.
Aspect 9: The method of any of Aspects 1-8, wherein the indication of the jitter comprises: a default value of the jitter that is implicitly indicated based at least in part on the PDU set omitting an explicit indication of the jitter, a quantized value of the jitter, or a field value that maps to a value of the jitter.
Aspect 10: The method of Aspect 9, wherein the indication of the jitter comprises a default value of the jitter that is implicitly indicated based at least in part on the PDU set omitting an explicit indication of the jitter, and wherein the default value is zero or a maximum allowed jitter.
Aspect 11: The method of any of Aspects 1-10, further comprising time-synchronizing, with an application server associated with the PDU set, to obtain synchronized timing between the application server and the network node, wherein the indication of the deadline includes the indication of the absolute time of the deadline, and wherein the absolute time of the deadline is based at least in part on the synchronized timing.
Aspect 12: The method of any of Aspects 1-11, wherein the deadline is based at least in part on one or more of: a jitter of packet generation times of the PDU set, a dejitter buffer status of an application client associated with the PDU set, or a shift in packet generation time associated with a phase locked loop at an application layer associated with the PDU set.
Aspect 13: The method of any of Aspects 1-12, further comprising scheduling the transmission of the PDU set based at least in part on the indication of the deadline, wherein transmitting the PDU set is based at least in part on scheduling the transmission.
Aspect 14: A method of wireless communication performed by an application server, comprising: providing an indication of a deadline for transmission of a protocol data unit (PDU) set, the indication of the deadline including one or more of: an indication of a jitter of the PDU set, an indication of a packet delay budget that is based at least in part on the jitter of the PDU set and a nominal PDU set delay budget (PSDB), or an indication of an absolute time of the deadline; and receiving the PDU set at a time that is based at least in part on the indication of the deadline.
Aspect 15: The method of Aspect 14, wherein providing the indication of the deadline comprises providing the indication of the deadline via one or more of: metadata of the PDU set, a header of the PDU set, a real-time transport (RTP) protocol header.
Aspect 16: The method of any of Aspects 14-15, further comprising: providing an indication of the nominal PSDB associated with a flow that includes the PDU set.
Aspect 17: The method of any of Aspects 14-16, wherein the deadline is based at least in part on the nominal PSDB with an offset that is based at least in part on the jitter.
Aspect 18: The method of any of Aspects 14-17, further comprising: receiving an indication of a maximum allowed jitter associated with a flow that includes the PDU set.
Aspect 19: The method of any of Aspects 14-18, wherein the indication of the jitter comprises: a default value of the jitter that is implicitly indicated based at least in part on the PDU set omitting an explicit indication of the jitter, a quantized value of the jitter, or a field value that maps to a value of the jitter.
Aspect 20: The method of Aspect 19, wherein the indication of the jitter comprises a default value of the jitter that is implicitly indicated based at least in part on the PDU set omitting an explicit indication of the jitter, and wherein the default value is zero or a maximum allowed jitter.
Aspect 21: The method of any of Aspects 14-20, further comprising time-synchronizing, with an application server associated with the PDU set, to obtain synchronized timing between the application server and the network node, wherein the indication of the deadline includes the indication of the absolute time of the deadline, and wherein the absolute time of the deadline is based at least in part on the synchronized timing.
Aspect 22: The method of any of Aspects 14-21, wherein the deadline is based at least in part on one or more of: a jitter of packet generation times of the PDU set, a dejitter buffer status of an application client associated with the PDU set, or a shift in packet generation time associated with a phase locked loop at an application layer associated with the PDU set.
Aspect 23: An apparatus for wireless communication at a device, comprising a processor; memory coupled with the processor; and instructions stored in the memory and executable by the processor to cause the apparatus to perform the method of one or more of Aspects 1-22.
Aspect 24: A device for wireless communication, comprising a memory and one or more processors coupled to the memory, the one or more processors configured to perform the method of one or more of Aspects 1-22.
Aspect 25: An apparatus for wireless communication, comprising at least one means for performing the method of one or more of Aspects 1-22.
Aspect 26: A non-transitory computer-readable medium storing code for wireless communication, the code comprising instructions executable by a processor to perform the method of one or more of Aspects 1-22.
Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, to a network node, an indication of one or more of a deadline, a periodicity, a nominal packet delay budget, a jitter of burst arrival times, or a nominal arrival time of data packets of a communication session; and
receive one or more data packets based at least in part on the one or more data packets arriving at or before the deadline.

2. The UE of claim 1, wherein the one or more processors are further configured to:
receive, from an application client at the UE, information indicating the deadline, the periodicity, the nominal packet delay budget, the jitter of burst arrival times, or the nominal arrival time of data packets of the communication session.

3. The UE of claim 2, wherein the one or more processors are further configured to:
convert the deadline into a radio access network (RAN) time domain to create a converted deadline, the deadline indicated by the indication being the converted deadline.

4. The UE of claim 3, wherein the one or more processors, to convert the deadline into a RAN time domain, are configured to convert the deadline from an application time domain to the RAN time domain based at least in part on one or more of:
deadline mapping associated with a quality of service (QoS) flow,
one or more deadline notification messages, or
one or more data radio bearer (DRB) QoS parameters associated with the deadline.

5. The UE of claim 3, wherein the one or more processors are further configured to:
identify a burst index of the data packets based at least in part on one or more of:
burst metadata available at an application layer of the data packets, or
a determined burst index based at least in part on timing of the data packets,
wherein the deadline is a periodic deadline, and
wherein the burst index is associated with an occasion of the deadline.

6. The UE of claim 1, wherein the one or more processors are further configured to:
identify an internet protocol (IP) flow to which the deadline applies, the IP flow being associated with the data packets and identified based at least in part on one or more of:
an indication of the IP flow via an application layer of the data packets, or
a determined logical channel identification based at least in part on an IP packet index of the data packets; and
translate the IP flow into a quality of service (QoS) flow to which the deadline applies.

7. The UE of claim 1, wherein the one or more processors are further configured to transmit one or more of:
an indication that a quality of service (QoS) flow or a logical channel associated with the data packets is associated with the deadline,
an indication of a burst index associated with an occasion of the deadline, or
an indication that a logical channel identification associated with the data packets is associated with the deadline.

8. The UE of claim 1, wherein the one or more processors are further configured to:
receive an additional indication that a QoS flow or logical channel is configured with the deadline; and
transmit an indication that the QoS flow or logical channel associated with the data packets is associated with the deadline.

9. The UE of claim 1, wherein the one or more processors are further configured to one or more of:
receive an indication that expiration of the data packets of the communication session is associated with the deadline and is not associated with a packet delay budget;
transmit an indication that expiration of the data packets of the communication session is associated with the deadline and is not associated with a packet delay budget; or
receive an indication of acceptance of the deadline, the periodicity, the nominal packet delay budget, the jitter of burst arrival times, or the nominal arrival time of data packets of the communication session.

10. The UE of claim 1, wherein the deadline is associated with a periodic display time and a UE internal data processing time.

11. The UE of claim 1, wherein the one or more processors are further configured to:
receive an indication of a downlink resource for receiving the data packets, the downlink resource based at least in part on the indication of the deadline, the periodicity, the nominal packet delay budget, the jitter of burst arrival times, or the nominal arrival time of data packets of the communication session,
wherein the data packets are received based on the downlink resource.

12. The UE of claim 1, wherein the one or more processors are further configured to receive an indication of a mapping of quality of service (QoS) flows to internet protocol (IP) flows,
wherein the one or more processors, to transmit the indication of the deadline, the periodicity, the nominal packet delay budget, the jitter of burst arrival times, or the nominal arrival time, are configured to:
transmit, based at least in part on the mapping of the QoS flows to the IP flows, an additional indication that a QoS flow is associated with the deadline, the periodicity, the nominal packet delay budget, the jitter of burst arrival times, or the nominal arrival time.

13. A network node for wireless communication, comprising:
a memory; and
one or more processors, coupled to the memory, configured to:
receive an indication of one or more of a deadline, a periodicity, a nominal packet delay budget, a jitter of burst arrival times, or a nominal arrival time associated with data packets of a communication session; and
transmit one or more data packets based at least in part on the one or more data packets transmitted at or before the deadline.

14. The network node of claim 13, wherein the one or more processors, to receive the indication, are configured to one or more of:
receive, from a user equipment (UE) associated with the data packets, information indicating one or more of the deadline, the periodicity, the nominal packet delay budget, the jitter of burst arrival times, or the nominal arrival time of data packets of the communication session, or
receive, from an application server associated with the data packets, information indicating the deadline, the periodicity, the nominal packet delay budget, the jitter of burst arrival times, or the nominal arrival time of data packets of the communication session.

15. The network node of claim 13, wherein the deadline is associated with a periodic display time and a UE internal data processing time.

16. The network node of claim 13, wherein the one or more processors are further configured to:
transmit an indication of a downlink resource for receiving the data packets, the downlink resource based at least in part on the indication of the deadline, a periodicity, a nominal packet delay budget, the jitter of burst arrival times, or the nominal arrival time of data packets of the communication session,
wherein the data packets are received by a receiving device based at least in part on the downlink resources.

17. The network node of claim 13, wherein the one or more processors are further configured to:
group data packets into a burst group based at least in part on the indication of the deadline, a periodicity, a nominal packet delay budget, the jitter of burst arrival times, or the nominal arrival time of data packets of the communication session.

18. The network node of claim 13, wherein the one or more processors are further configured to receive one or more of:
an indication that a quality of service (QoS) flow associated with the data packets is associated with the deadline,
an indication of a burst index associated an occasion of the deadline, or
an indication that a logical channel identification associated with the data packets is associated with the deadline.

19. The network node of claim 13, wherein the one or more processors are further configured to:
transmit an additional indication that a quality of service (QoS) or logical channel is configured with the deadline based at least in part on receiving an indication that the QoS flow or logical channel associated with the data packets is associated with the deadline.

20. The network node of claim 13, wherein the one or more processors are further configured to:
transmit an indication of a mapping of quality of service (QoS) flows to internet protocol (IP) flows for translating an IP flow to which the deadline applies into a QoS flow to which the deadline applies.

21. The network node of claim 13, wherein the one or more processors are further configured to:
transmit an indication of acceptance of the deadline, the periodicity, the nominal packet delay budget, the jitter of burst arrival times, or the nominal arrival time of data packets of the communication session.

22. The network node of claim 13, wherein the one or more processors, to receive the indication of the deadline, are configured to receive the indication of the deadline via a centralized unit, and
wherein the network node comprises a distributed unit.

23. The network node of claim 13, wherein the one or more processors, to transmit the one or more data packets, are configured to:
identify a quality of service (QoS) flow associated with the data packets;
apply the deadline to the data packets based at least in part on the QoS flow being associated with the deadline; and
apply a periodic occasion of the deadline to the data packets based at least in part on a time at which the network node receives the data packets or an indication of a burst number of the data packets.

24. The network node of claim 13, wherein the one or more processors, to receive the jitter of burst arrival times, are configured to:
receive an indication of the jitter of burst arrival times in a user plane header.

25. The network node of claim 13, wherein the jitter of burst arrival times is based at least in part on an actual burst arrival times and a nominal arrival time.

26. The network node of claim 13, wherein the one or more processors are further configured to one or more of:
receive an indication that expiration of the data packets of the communication session is associated with the deadline and is not associated with a packet delay budget;
transmit an indication that expiration of the data packets of the communication session is associated with the deadline and is not associated with a packet delay budget;
drop one or more additional data packets based at least in part on the one or more additional data packets failing to satisfy the deadline; or
identify the deadline based at least in part on one or more of the periodicity, the nominal packet delay budget, the jitter of burst arrival times, or the nominal arrival time of data packets.

27. The network node of claim 13, wherein the one or more processors, to receive the indication of the deadline, are configured to receive the indication of the deadline via one or more of:
metadata of the data packets,
a header of the data packets,
a general packet radio service (GPRS) tunnelling protocol user plane (GTP-U) header of the data packets,
a real-time transport (RTP) protocol header, or
a secure real-time transport (SRTP) protocol header.

28. The network node of claim 27, wherein the deadline of each PDU set or PDU is indicated by a PDU set delay budget (PSDB) or packet delay budget (PDB) until the deadline.

29. A method of wireless communication performed by a user equipment (UE), comprising:
transmitting, to a network node, an indication of one or more of a deadline, a periodicity, a nominal packet delay budget, a jitter of burst arrival times, or a nominal arrival time of data packets of a communication session; and
receiving one or more data packets based at least in part on the one or more data packets arriving at or before the deadline.

30. A method of wireless communication performed by a network node, comprising:
receiving an indication of one or more of a deadline, a periodicity, a nominal packet delay budget, a jitter of burst arrival times, or a nominal arrival time associated with data packets of a communication session; and
transmitting one or more data packets based at least in part on the one or more data packets transmitted at or before the deadline.
